(19) United States
(12) Patent Application Publication
(10) Pub. No.: US 2017/0090729 A1
(43) Pub. Date: Mar. 30, 2017

(54) Organization and Visualization of Content from Multiple Media Sources

(71) Applicant: The Boeing Company, Chicago, IL (US)

(72) Inventors: Monica de Lima Nogueira, Chapel Hill, NC (US); Noel Peyton Greis, Chapel Hill, NC (US); William G. Arnold, Jacksonville, FL (US); Aurelio Frank DiScala, Holly Springs, NC (US); Royce Hamilton Kwock Fai Kam, San Diego, CA (US); Matthew Kanfeng Yang, San Diego, CA (US); Holton Stonestreet Thompson, Hampstead, NC (US)

(21) Appl. No.: 14/871,320

(22) Filed: Sep. 30, 2015

(51) Int. Cl. G06F 3/0484; G06F 17/27; G06T 9/00; G06T 11/20; G06F 3/0482

(52) U.S. Cl. CPC G06F 3/04845; G06T 11/206; G06F 3/0482; G06F 3/04842; G06T 9/00; G06F 17/2705; G06F 17/277; G06F 2203/04806

(57) ABSTRACT

A method, apparatus, and system for visually representing content in media sources. A plurality of vectors is created, by a computer system, for the media sources based on content in the media sources and a lexicon built for a selected subject. The plurality of vectors include elements that represent matches between base entities in the lexicon and extracted entities from the content in the media sources. A visual representation of the content in the media sources based on the plurality of vectors is displayed, by the computer system, through a graphical user interface that is configured to enable a user to navigate through the content. The visual representation of the content is transformed in real-time, by the computer system, based on user input such that changes to the visual representation of the content in the graphical user interface visually track the user navigating through the content.

### BACKGROUND INFORMATION

1. Field

The present disclosure relates generally to managing information and, in particular, to the organization and visualization of content from multiple sources. Still more particularly, the present disclosure relates to a method and apparatus for organizing and visually presenting content from multiple media sources in a manner that enables user-driven navigation through this content.

2. Background

Different types of sources may provide information about different types of businesses. Sources of information include, but are not limited to, online news articles, digital publications, web-based news feeds, online historical records, proprietary business reports, and other types of sources. Analyzing the information provided by these numerous sources of information may be more challenging and time-consuming than desired in certain industries.

For example, without limitation, information related to a particular aerospace product in the aerospace industry may be obtained from hundreds to thousands of articles. Over the lifecycle of the particular aerospace product, the number of articles related to the particular aerospace product may increase from the thousands into the tens of thousands, into the hundreds of thousands, and even into the millions, in some cases.

Over time, organizing the content of this overwhelming number of articles in a manner that enables a user to quickly and easily identify information related to a particular subject may be more difficult and time-consuming than desired using some currently available methods for managing information. Therefore, it would be desirable to have a method and apparatus that take into account at least some of the issues discussed above, as well as other possible issues.

### SUMMARY

In one illustrative embodiment, an apparatus comprises a display module, a vector generator module, and a visualizer module. The display module is implemented in a computer system and configured to display a graphical user interface. The vector generator module is implemented in the computer system and configured to generate a plurality of vectors. The vector generator module generates the plurality of vectors for a plurality of media sources based on content in the plurality of media sources and a lexicon that is built for a selected subject. The plurality of vectors include elements that represent matches between base entities in the lexicon and extracted entities from the content in the plurality of media sources. The visualizer module is implemented in the computer system, coupled to the vector generator module and the display module, and configured to display a visual representation of the content in the plurality of media sources in the graphical user interface. The plurality of vectors and the graphical user interface are configured to enable a user to navigate through the content. The visualizer module is further configured to visually transform the visual representation of the content in the graphical user interface in real-time based on user input.

In another illustrative embodiment, a computer-implemented electronic media content navigation system comprises a display module, a data structure, a vector generator module, and a visualizer module. The display module is implemented in a computer system and configured to display a graphical user interface. The data structure stores a lexicon that is built for a selected subject. The vector generator module is implemented in the computer system and configured to access a plurality of media sources through a computer network and generate a plurality of vectors for the plurality of media sources based on the lexicon and content in the plurality of media sources. The plurality of vectors generated by the vector generator module include elements that represent matches between base entities in the lexicon and extracted entities from the content in the plurality of media sources. The visualizer module is implemented in the computer system, coupled to the vector generator module and the display module, and configured to display a visual representation of the content in the plurality of media sources in the graphical user interface. The plurality of vectors and the graphical user interface are configured to enable a user to navigate through the content. The visualizer module is further configured to visually transform the visual representation of the content in the graphical user interface in real-time based on user input.

In yet another illustrative embodiment, a method is provided for visually representing content in a plurality of media sources. A plurality of vectors is created, by a computer system, for the plurality of media sources based on content in the plurality of media sources and a lexicon built for a selected subject. The plurality of vectors include elements that represent matches between base entities in the lexicon and extracted entities from the content in the plurality of media sources. A visual representation of the content in the plurality of media sources based on the plurality of vectors is displayed, by the computer system, through a graphical user interface that is configured to enable a user to navigate through the content. The visual representation of the content in the graphical user interface is transformed, by the computer system, in real-time based on user input such that changes to the visual representation of the content in the graphical user interface visually track the user navigating through the content.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a content management system in the form of a block diagram in accordance with an illustrative embodiment;

FIG. 2 is an illustration of a content diver and a graphical user interface in the form of a block diagram in accordance with an illustrative embodiment;

FIG. 3 is an illustration of a map manager and a graphical user interface in the form of a block diagram in accordance with an illustrative embodiment;

FIG. 4 is an illustration of a dive interface within a graphical user interface in accordance with an illustrative embodiment;

FIG. 5 is an illustration of a dive interface within a graphical user interface in accordance with an illustrative embodiment;

FIG. 6 is an illustration of a dive interface within a graphical user interface in accordance with an illustrative embodiment;

FIG. 7 is an illustration of a map environment within a graphical user interface in accordance with an illustrative embodiment;

FIG. 8 is an illustration of a zoomed in view of a map in accordance with an illustrative embodiment;

FIG. 9 is an illustration of a tag window displayed in a graphical user interface in accordance with an illustrative embodiment;

FIG. 10 is an illustration of a map environment in a graphical user in accordance with an illustrative embodiment;

FIG. 11 is an illustration of a dashboard in accordance with an illustrative embodiment;

FIG. 12 is an illustration of a customization window displayed over a dashboard in accordance with an illustrative embodiment;

FIG. 13 is an illustration of a dashboard in accordance with an illustrative embodiment;

FIG. 14 is an illustration of a process for visually representing information in the form of a flowchart in accordance with an illustrative embodiment;

FIG. 15 is an illustration of a process for creating a vector for a media source in the form of a flowchart in accordance with an illustrative embodiment;

FIG. 16 is an illustration of a process for displaying a visual representation of content in a plurality of media sources in the form of a flowchart in accordance with an illustrative embodiment;

FIG. 17 is an illustration of a process for transforming a visual representation of content in a graphical user interface in the form of a flowchart in accordance with an illustrative embodiment;

FIGS. 18A and 18B are illustrations of a process for facilitating user-driven navigation through content in a plurality of media sources in the form of a flowchart in accordance with an illustrative embodiment; and

FIG. 19 is an illustration of a data processing system in the form of a block diagram in accordance with an illustrative embodiment.

### DETAILED DESCRIPTION

The illustrative embodiments recognize and take into account different considerations. For example, the illustrative embodiments recognize and take into account that it may be desirable to have a method and apparatus for organizing the content of multiple sources of information. Further, the illustrative embodiments recognize and take into account that it may be desirable to have a method and apparatus for visually presenting the content of these sources of information in a manner that enables a user to quickly and easily navigate through the content.

Thus, the illustrative embodiments provide a method and apparatus for visually representing information in a manner that enables a user to quickly and easily identify information related to a particular subject if interest. In one illustrative example, a plurality of vectors are created by a computer system for a plurality of media sources based on content in the plurality of media sources and a lexicon built for a selected subject. A visual representation of the content in the plurality of media sources is displayed, by the computer system, through a graphical user interface displayed on a display system based on the plurality of vectors. The visual representation of the content may facilitate a user navigating through the content. The visual representation of the content in the graphical user interface may be transformed, by the computer system, such that changes to the visual representation of the content in the graphical user interface visually track the user navigating through the content.

Referring now to the figures, in these illustrative examples, the same reference numeral may be used in more than one figure. The reuse of a particular reference numeral in different figures represents the same element in these different figures.

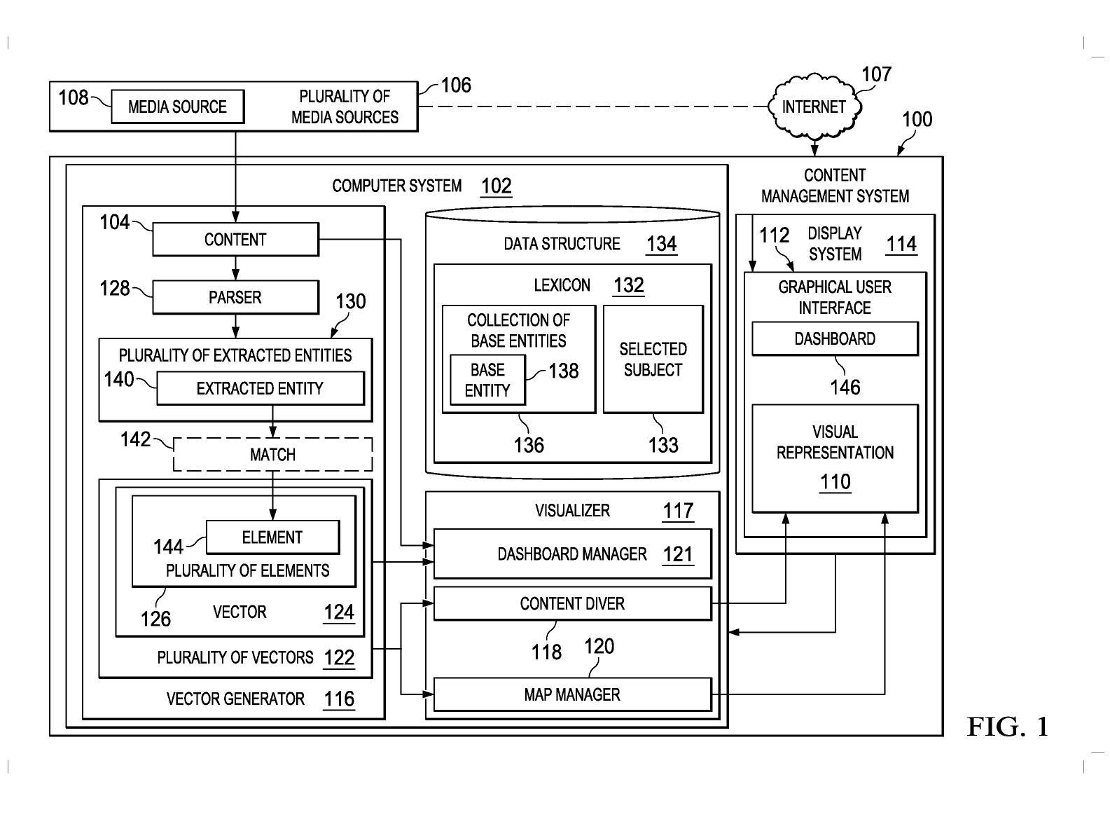

With reference to FIG. 1, an illustration of a content management system is depicted in the form of a block diagram in accordance with an illustrative embodiment. In one illustrative example, content management system 100 may be implemented using computer system 102. Computer system 102 may comprise one computer or multiple computers that are in communication with each other.

Content management system 100 may be used to manage content 104 that may be obtained from plurality of media sources 106 and to allow a user to navigate through content 104. In one illustrative example, each media source in plurality of media sources 106 is an electronic media source. In this manner, content management system 100 may also be referred to as an electronic media content navigation system.

Media source 108 may be an example of one of plurality of media sources 106. Media source 108 may take different forms. In these illustrative examples, media source 108 may take the form of any written work in electronic form. For example, without limitation, media source 108 may take the form of an online news article, a digital report, a web-based news feed, a historical digital report, an online proprietary report, or some other type of electronic source of information. Depending on the implementation, content management system 100 may access or otherwise retrieve content 104 from plurality of media sources 106 through Internet 107 or some other type of communications network or computer network. Internet 107 refers to a system of interconnected computer networks.

As depicted, content management system 100 may be used to generate visual representation 110 of content 104. Visual representation 110 may be displayed in graphical user interface 112 on display system 114. Depending on the implementation, display system 114 may take the form of one or more display devices. A display module that is implemented in computer system 102 may be configured to display graphical user interface 112 on display system 114.

In these illustrative examples, content management system 100 may include vector generator 116 and visualizer 117 that are coupled to each other. Visualizer 117 may include content diver 118, map manager 120, dashboard manager 121, or a combination thereof.

Each of vector generator 116 and visualizer 117 may be implemented using software, hardware, firmware, or a combination thereof. Visualizer 117 may be coupled to the display module that is used to display graphical user interface 112. In some illustrative examples, visualizer 117 and the display module may be implemented together in a same module that comprises hardware, software, firmware, or a combination thereof. Further, each of content diver 118, map manager 120, and dashboard manager 121 may be implemented using software, hardware, firmware, or a combination thereof.

When software is used, the operations performed by vector generator 116, content diver 118, map manager 120, dashboard manager 121, or a combination thereof may be implemented using, for example, without limitation, program code configured to run on a processor unit. When firmware is used, the operations may be implemented using, for example, without limitation, program code and data and stored in persistent memory to run on a processor unit.

When hardware is employed, the hardware may include one or more circuits that operate to perform the operations performed by vector generator 116, content diver 118, map manager 120, dashboard manager 121, or a combination thereof. Depending on the implementation, the hardware may take the form of a circuit system, an integrated circuit, an application specific integrated circuit (ASIC), a programmable logic device, or some other suitable type of hardware device configured to perform any number of operations.

A programmable logic device may be configured to perform certain operations. The device may be permanently configured to perform these operations or may be reconfigurable. A programmable logic device may take the form of, for example, without limitation, a programmable logic array, a programmable array logic, a field programmable logic array, a field programmable gate array, or some other type of programmable hardware device. In some illustrative examples, each of vector generator 116, content diver 118, map manager 120, and dashboard manager 121 may be implemented in the same processor or a different processor.

In some cases, vector generator 116 may be referred to as a vector generator module that is implemented in computer system 102. Visualizer 117 may also be referred to as a visualizer module that is implemented in computer system 102. Further, content diver 118, map manager 120, and dashboard manager 121 may be referred to as a content diver module, a map manager module, and a dashboard manager module, respectively, all of which may be implemented in computer system 102.

Vector generator 116 may receive content 104 from plurality of media sources 106 and generate plurality of vectors 122 for plurality of media sources 106. Vector 124 may be an example of one of plurality of vectors 122 generated by vector generator 116. In this illustrative example, vector 124 comprises plurality of elements 126.

In one illustrative example, vector generator 116 accesses plurality of media sources 106 over a computer network, such as Internet 107. For example, vector generator 116 may download plurality of media sources 106 from Internet 107 or retrieve a copy of each of plurality of media sources 106 over Internet 107.

For example, vector generator 116 may include parser 128. Parser 128 may be implemented using software, firmware, hardware, or a combination thereof. Parser 128 may also be referred to as a parser module that is implemented in computer system 102.

In one illustrative example, parser 128 may access or retrieve content 104 in media source 108 and process content 104 to form plurality of extracted entities 130. For example, parser 128 may be implemented using at least one of an unstructured text entity extractor, a named entity extractor, a named entity recognizer (NER), or some other type of information extractor to extract entities from content 104.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required.

For example, without limitation, “at least one of item A, item B, or item C” or “at least one of item A, item B, and item C” may mean item A; item A and item B; item B; item A, item B, and item C; item B and item C; or item A and item C. In some cases, “at least one of item A, item B, or item C” or “at least one of item A, item B, and item C” may mean, but is not limited to, two of item A, one of item B, and ten of item C; four of item B and seven of item C; or some other suitable combination.

An entity, as used herein, may be a word, a phrase, or some other part or constituent of text that has meaning or relevance to selected subject 133. For example, without limitation, an entity may be text that describes a thing, a person, a place, a name, a product, an organization, an industry, a service, an operation, an action, a state, an attribute, a property, a decision, or some other type of subject matter area. Depending on the implementation, selected subject 133 may take the form of, but is not limited to, a category of products, a particular product, an industry, a business entity, an organization, a service, a category of services, or some other type of subject matter.

Each extracted entity in plurality of extracted entities 130 is an entity that has been extracted from media source 108. In one illustrative example, parser 128 may use at least one of a set of predefined criteria, a policy, a complex algorithm, an information extraction process, or some other suitable process to form plurality of extracted entities 130.

In some cases, each entity in plurality of extracted entities 130 may be distinct. In these cases, when content 104 in media source 108 includes 20 instances of the entity “aviation,” only one extracted entity for “aviation” may be generated. As another illustrative example, the phrase “maintenance and repair” may appear multiple times in content 104 of media source 108. However, only one extracted entity for “maintenance and repair” may be generated.

Vector generator 116 uses plurality of extracted entities 130 and lexicon 132 to generate plurality of vectors 122. Lexicon 132 may be built for selected subject 133 and stored in data structure 134. Data structure 134 may take the form of a database, a spreadsheet, a table, a document, an associative memory, or some other type of data storage.

Lexicon 132 comprises collection of base entities 136 related to selected subject 133. Base entity 138 may be an example of one base entity in collection of base entities 136. In some illustrative examples, base entity 138 may be a root entity that represents a family of derivatives of a particular entity.

In one illustrative example, lexicon 132 is built by content management system 100 using at least one of user-specified factors, historical data, a predetermined ontology, a predefined listing of entities, or other suitable factors. In another illustrative example, lexicon 132 may be built using at least one of a query that is pared, a key word list that has been generated from a media source of interest, an index, a product list, or some other type of source.

Vector generator 116 processes content 104 in each media source in plurality of media sources 106 using lexicon 132. For example, without limitation, vector generator 116 may compare each extracted entity in plurality of extracted entities 130 to collection of base entities 136. In some illustrative examples, vector generator 116 may use at least one of an associative memory or a neural network to perform this comparison and to generate plurality of vectors 122.

Extracted entity 140 is an example of one of plurality of extracted entities 130 created for media source 108. Vector generator 116 compares extracted entity 140 to collection of base entities 136 to determine whether extracted entity 140 matches any of the base entities in collection of base entities 136.

If vector generator 116 identifies match 142 between extracted entity 140 and, for example, base entity 138, vector generator 116 determines whether a corresponding element for base entity 138 already exists in vector 124. If a corresponding element does not already exist, element 144 is created and added to vector 124 for media source 108. In this manner, element 144 corresponds to base entity 138.

Element 144 may identify base entity 138. For example, element 144 may take the form of base entity 138 itself. In this manner, plurality of elements 126 in vector 124 may also be referred to as a plurality of entities. In other illustrative examples, element 144 may take the form of some other type of textual or symbolic representation of base entity 138, depending on the implementation.

Further, element 144 includes a weight value. This weight value may be used to represent or indicate the number of occurrences of recognition of base entity 138 within content 104 of media source 108. In some cases, this weight value may be a normalized weight value. If vector generator 116 determines that a corresponding element for base entity 138 already exists in vector 124, then a weight value for that corresponding element is updated to reflect the new occurrence.

Each of plurality of extracted entities 130 created for media source 108 may be similarly processed to generate vector 124 for media source 108. Further, content 104 from each media source in plurality of media sources 106 may be similarly processed to form plurality of vectors 122 for plurality of media sources 106.

In one illustrative example, content 104 may be obtained from plurality of media sources 106 continuously or periodically over time. As new media sources are accessed, new vectors are generated by vector generator 116. In some cases, lexicon 132 may be modified over time.

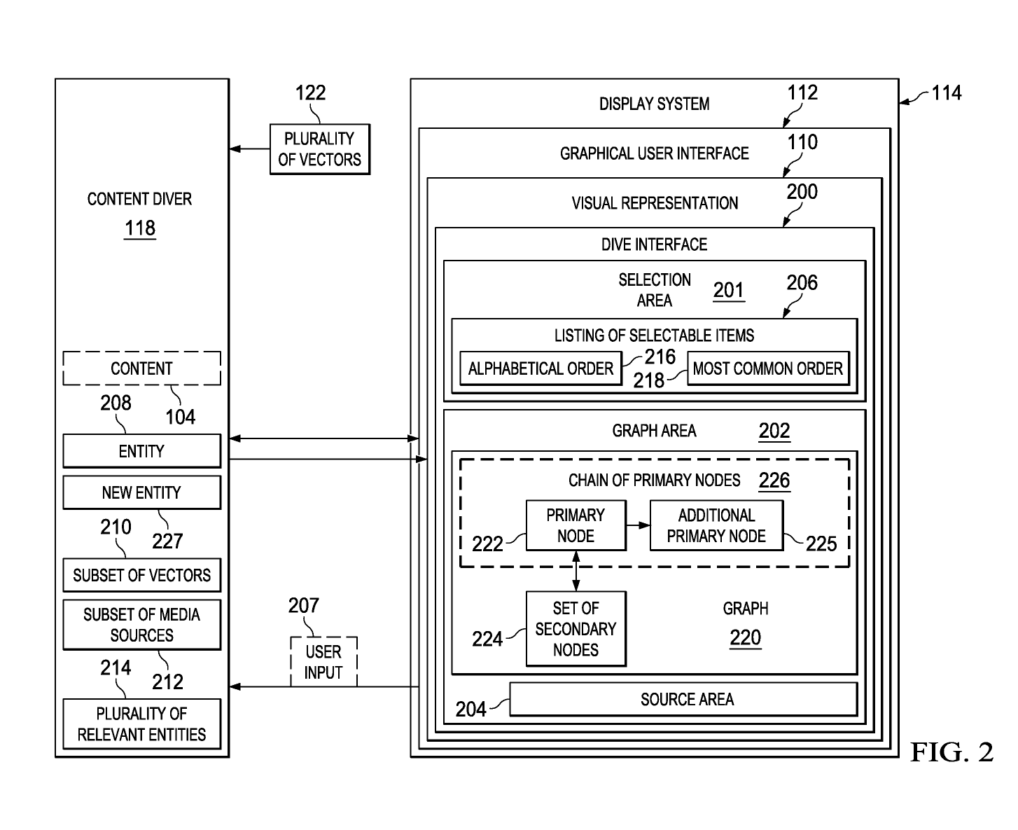

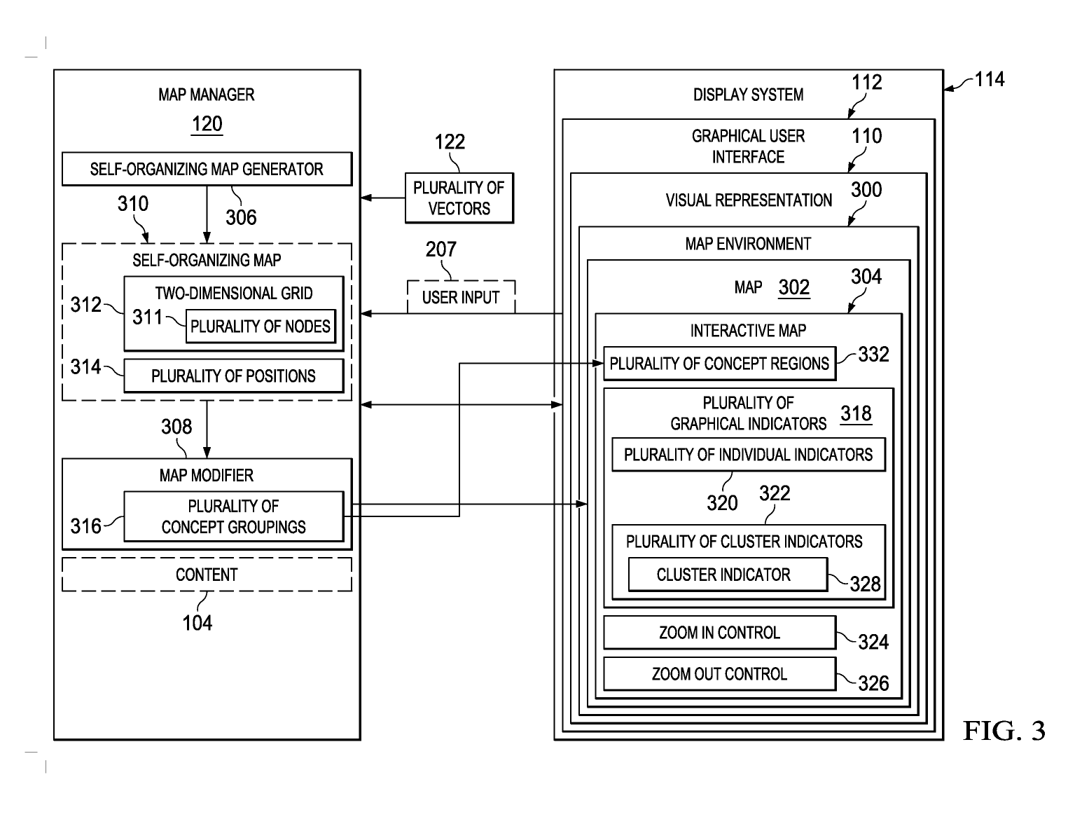

Visualizer 117 may use plurality of vectors 122 to visually represent content 104 in plurality of media sources 106 in graphical user interface 112. In particular, content diver 118 and map manager 120 may visually represent content 104 in plurality of media sources 106 in graphical user interface 112 in a manner that facilitates easier and quicker navigation through content 104. Content diver 118 and map manager 120 are described in greater detail further below in FIGS. 2-3.

With reference still to FIG. 1, dashboard manager 121 may visually present at least a portion of content 104 in dashboard 146 in graphical user interface 112. In one illustrative example, dashboard 146 takes the form of a graphical representation of a snapshot of content 104 in a portion of plurality of media sources 106 in graphical user interface 112. Dashboard manager 121 may update this graphical presentation over time as new content is obtained from various media sources.

With reference now to FIG. 2, an illustration of content diver 118 and graphical user interface 112 from FIG. 1 is depicted in the form of a block diagram in accordance with an illustrative embodiment. In this illustrative example, content diver 118 may be used to visually represent content 104 in graphical user interface 112 in a manner that enables a user to easily and quickly navigate through content 104 to access information of interest.

As depicted, content diver 118 may display visual representation 110 in the form of dive interface 200 within graphical user interface 112. Dive interface 200 may include selection area 201, graph area 202, and source area 204.

In some illustrative examples, content diver 118 displays listing of selectable items 206 within selection area 201 prior to any user input being received through graphical user interface 112. Listing of selectable items 206 may identify entities found in plurality of vectors 122 for plurality of media sources 106 in FIG. 1. In one illustrative example, listing of selectable items 206 may identify every distinct entity found in plurality of vectors 122. In another illustrative example, listing of selectable items 206 includes every distinct entity that is found in more than some predetermined threshold number of vectors in plurality of vectors 122.

In other illustrative examples, no listing may be displayed in selection area 201 until user input 207 has been received through graphical user interface 112. In this manner, the initial creation of listing of selectable items 206 may be user-driven.

Content diver 118 may receive user input 207 through graphical user interface 112. In one illustrative example, user input 207 may first identify entity 208, which may be a base entity in this illustrative example. For example, without limitation, user input 207 may be text that can be recognized by content diver 118 as identifying entity 208. Based on entity 208, content diver 118 may transform dive interface 200. For example, in response to a selection of entity 208 through user input 207, content diver 118 may identify subset of vectors 210 within plurality of vectors 122 that includes entity 208.

Subset of vectors 210 may directly correspond to subset of media sources 212 within plurality of media sources 106 in FIG. 1. In one illustrative example, content diver 118 displays a listing of the media sources in subset of media sources 212 within source area 204 in dive interface 200. This listing may include, for example, without limitation, a date of publication, a title, a hyperlink, and other information for each media source in subset of media sources 212.

Further, content diver 118 identifies plurality of relevant entities 214 that correspond to entity 208 with respect to subset of vectors 210. A relevant entity, as used herein, is one that is related to another entity, which in this illustrative example, is entity 208. A relevant entity in plurality of relevant entities 214 is an entity that is found in one or more vectors of subset of vectors 210. Plurality of relevant entities 214 includes all of the entities in subset of vectors 210. Content diver 118 may update listing of selectable items 206 in selection area 201 of dive interface 200 such that each selectable item in listing of selectable items 206 identifies a corresponding relevant entity in plurality of relevant entities 214.

In some cases, diver interface 200 may provide a user with the option to sort listing of selectable items 206 in alphabetical order 216, most common order 218, or some other type of order. Most common order 218 may be a sorting in which, for example, the relevant entity that is most commonly found in subset of vectors 210 is listed at the top of listing of selectable items 206.

Based on the selection of entity 208 through user input 207, content diver 118 also displays graph 220 within graph area 202 of dive interface 200. In particular, the creation of graph 220 is initiated by user input 207. Graph 220 may include primary node 222 and set of secondary nodes 224 connected to primary node 222. Graph 220 may be presented such that primary node 222 is visually distinguishable from set of secondary nodes 224. For example, without limitation, primary node 222 may be in a different font color, background color, highlighted differently, or otherwise visually distinguished from set of secondary nodes 224.

Primary node 222 may be a graphical representation of entity 208, which was identified through user input 207. Primary node 222 is thus initialized by user input 207. Primary node 222 identifies both entity 208 and a quantity of vectors from plurality of vectors 122 included in subset of vectors 210. Because each vector corresponds to a media source, the quantity identified by primary node 222 indicates to a user the number of media sources that include entity 208 or otherwise involve entity 208.

Each secondary node in set of secondary nodes 224 may be a graphical representation of a relevant entity in plurality of relevant entities 214. Each secondary node may identify the corresponding relevant entity and a quantity of vectors in subset of vectors 210 that include that corresponding relevant entity.

In one illustrative example, set of secondary nodes 224 may be displayed only for a selected portion of plurality of relevant entities 214. For example, set of secondary nodes 224 may be used to visually represent the top three, five, six, or some other number of most commonly used relevant entities.

Graph 220 may be depicted in a manner that allows a user to quickly and easily grasp the number of media sources that involve different entities. Set of secondary nodes 224 provide an opportunity for the user to “dive” further into content 104.

For example, the user may enter user input 207 that selects a secondary node of set of secondary nodes 224. The selected secondary node may be transformed into additional primary node 225 that is visually distinguishable from the remaining secondary nodes in set of secondary nodes 224. Together, primary node 222 and additional primary node 225 may form chain of primary nodes 226.

The relevant entity identified in additional primary node 225 may then be treated as new entity 227 and processed in a manner similar to entity 208. Based on new entity 227, subset of vectors 210 may be narrowed to form a new subset of vectors that includes both entity 208 and new entity 227. The listing of media sources displayed in source area 204 may also be updated based on the new subset of media sources corresponding to the new subset of vectors. Further, a new plurality of relevant entities may be identified for this new subset of vectors. Listing of selectable items 206 may then be updated based on this new plurality of relevant entities. Further, content diver 118 updates graph 220 by adding a new set of secondary nodes to graph 220 that are connected to additional primary node 225 based on the new plurality of relevant entities.

In this manner, graph 220 may be used to navigate through content 104 of plurality of media sources 106 in FIG. 1. Graph 220 may be updated based on user input 207 to create a longer chain of primary nodes 226 with numerous secondary nodes connected to each primary node in chain of primary nodes 226.

Each time that a new primary node is added to chain of primary nodes 226, the listing of media sources within source area 204 is updated. The number of media sources listed decreases with each new primary node added to chain of primary nodes 226. In this manner, as chain of primary nodes 226 is created, a listing of hundreds to thousands of media sources may be filtered by user input 207 down to a more manageable, smaller set of media sources.

With reference now to FIG. 3, an illustration of map manager 120 and graphical user interface 112 from FIG. 1 is depicted in the form of a block diagram in accordance with an illustrative embodiment. In this illustrative example, map manager 120 displays visual representation 110 of content 104 from plurality of media sources 106 in FIG. 1 in graphical user interface 112 using map environment 300.

As depicted, map environment 300 includes map 302. In this illustrative example, map 302 may take the form of interactive map 304. Interactive map 304 enables a user to enter user input 207 directly through interactive map 304.

Map manager 120 may include self-organizing map generator 306 and map modifier 308. Each of self-organizing map generator 306 and map modifier 308 may be implemented using software, firmware, hardware, or a combination thereof.

In one illustrative example, self-organizing map generator 306 may be implemented using an artificial neural network (ANN) that is trained through learning to produce a low-dimensional, discretized representation of an input space of the training samples. This representation may be referred to as self-organizing map 310.

Self-organizing map generator 306 uses plurality of vectors 122 created by vector generator 116 in FIG. 1 to form self-organizing map 310. In one illustrative example, each node in plurality of nodes 311 represents a corresponding vector in plurality of vectors 122, and thereby, a corresponding media source in plurality of media sources 106 in FIG. 1.

In this illustrative example, self-organizing map 310 may include plurality of nodes 311 that are positioned on self-organizing map 310 with respect to two-dimensional grid 312. In other words, plurality of nodes 311 may have plurality of positions 314 within self-organizing map 310. In some cases, plurality of nodes 311 may also be referred to as a plurality of map points or a plurality of cells.

Each node in plurality of nodes 311 may be associated with a weight value and a position in two-dimensional space. Depending on the implementation, plurality of nodes 311 may include hundreds of nodes, thousands of nodes, tens of thousands of nodes, hundreds of thousands of nodes, millions of nodes, or some other number of nodes.

Plurality of positions 314 for plurality of nodes 311 may be generated such that nodes representing media sources that are more closely related to each other are positioned closer together within map 302. Further, nodes representing media sources that are less related to each other are positioned farther apart in map 302.

Map modifier 308 modifies self-organizing map 310 to create map 302 that is visually presented in map environment 300 in graphical user interface 112. In particular, map modifier 308 groups plurality of nodes 311 to form plurality of concept groupings 316 that are then visually presented in graphical user interface 112. For example, map modifier 308 may use one or more recursive algorithms to evaluate and group plurality of nodes 311.

Each concept grouping in plurality of concept groupings 316 may represent a grouping of nodes, and thereby, a grouping of media sources that are about, related to, or otherwise relevant to a particular concept. In this manner, plurality of concept groupings 316 may be referred to as a plurality of groupings of media sources. A concept grouping may include one or more nodes.

Each node of plurality of nodes 311 of self-organizing map 310 may include a weight value and a position. In one illustrative example, for each selected node, map modifier 308 evaluates each adjacent node around the selected node to determine whether the adjacent node may be grouped with the selected node with respect to a particular concept. This evaluation may be based on the weight value of the selected node and the weight value of the adjacent node. In some illustrative examples, the evaluation may be based on the two vectors corresponding to these two nodes. If the two vectors share a percentage of entities above some selected threshold, such as greater than about 40 percent or about 50 percent, then the two nodes are grouped.

For each adjacent node that is grouped with the selected node, that adjacent node is treated as the new selected node. The new adjacent nodes for the new selected node are then evaluated. In this manner, plurality of nodes 311 may be grouped to form plurality of concept groupings 316.

In one illustrative example, map manager 120 visually presents plurality of concept groupings 316 in map 302 by displaying graphical boundary lines in graphical user interface 112 that define plurality of concept groupings 316. Each bounded region of map 302 is a concept region that represents a concept grouping that includes one or more nodes of plurality of nodes 311. In this manner, map 302 may include plurality of concept regions 332 that represent plurality of concept groupings 316.

Further, map manager 120 displays plurality of graphical indicators 318 on map 302 in graphical user interface 112 to represent plurality of nodes 311. Plurality of graphical indicators 318 may include plurality of individual indicators 320 and plurality of cluster indicators 322. Each individual indicator in plurality of individual indicators 320 may represent a single node, and thereby, a single media source.

Each cluster indicator in plurality of cluster indicators 322 may represent a cluster of nodes, and thereby, a cluster of media sources. The clustering of nodes in map 302 may depend on the zoom level of map 302 that is displayed in graphical user interface 112.

For example, without limitation, graphical user interface 112 enables a user to zoom into map 302 to more clearly distinguish these graphical indicators. As one illustrative example, user input 207 may be entered through graphical user interface 112 to select zoom in control 324 or zoom out control 326. Zoom in control 324 and zoom out control 326 may be graphical control features.

In this illustrative example, a user-selection of zoom in control 324 may cause zooming into map 302 based on this zoom input within graphical user interface. In particular, map 302 may be zoomed into from a current zoom level to a new zoom level based on a zoom input received through zoom in control 324. Plurality of graphical indicators 318 displayed on map 302 may be updated based on the new zoom level. For example, one or more cluster indicators may be exploded out into multiple individual indicators, smaller cluster indicators, or both. Zooming in may allow a user to more clearly distinguish the various graphical indicators displayed in map 302.

Conversely, map 302 may be zoomed out from a current zoom level to a new zoom level based on a zoom input received through zoom out control 326. Plurality of graphical indicators 318 displayed on map 302 may be updated based on the new zoom level. For example, one or more cluster indicators may be created from multiple individual indicators, smaller cluster indicators, or both. Zooming out may allow a user to view more concept regions.

In one illustrative example, cluster indicator 328 may be used to visually represent multiple individual indicators that have been clustered based on the zoom level. The size, shape, color, or some other visual property of cluster indicator 328 may indicate the number of individual indicators represented by cluster indicator 328, and thereby, the number of media sources represented by cluster indicator 328. As one illustrative example, as the size of cluster indicator 328 increases, the number of media sources represented by cluster indicator 328 increases.

As one illustrative example, user input 207 may be received that selects cluster indicator 328. A selection of cluster indicator 328 may cause cluster indicator 328 to be exploded out and transformed into multiple individual indicators that represent multiple media sources. A user may be able to select an individual indicator to learn more information about the media source represented by that individual indicator.

In this manner, map 302 enables a user to navigate through content 104 quickly and easily by zooming into and zooming out of map 302. A user may zoom into a particular concept region of plurality of concept regions 332 in map 302 to find media sources that are about, related to, or otherwise relative to the concept corresponding to that concept region. Further, a user may use the various graphical indicators displayed on map 302 to navigate through content 104 of plurality of media sources 106 in FIG. 1.

The illustrations of content management system 100 in FIG. 1, graphical user interface 112 in FIGS. 1-3, content diver 118 in FIGS. 1-2, and map manager 120 in FIGS. 1 and 3 are not meant to imply physical or architectural limitations to the manner in which an illustrative embodiment may be implemented. Other components in addition to or in place of the ones illustrated may be used. Some components may be optional. Also, the blocks are presented to illustrate some functional components. One or more of these blocks may be combined, divided, or combined and divided into different blocks when implemented in an illustrative embodiment.

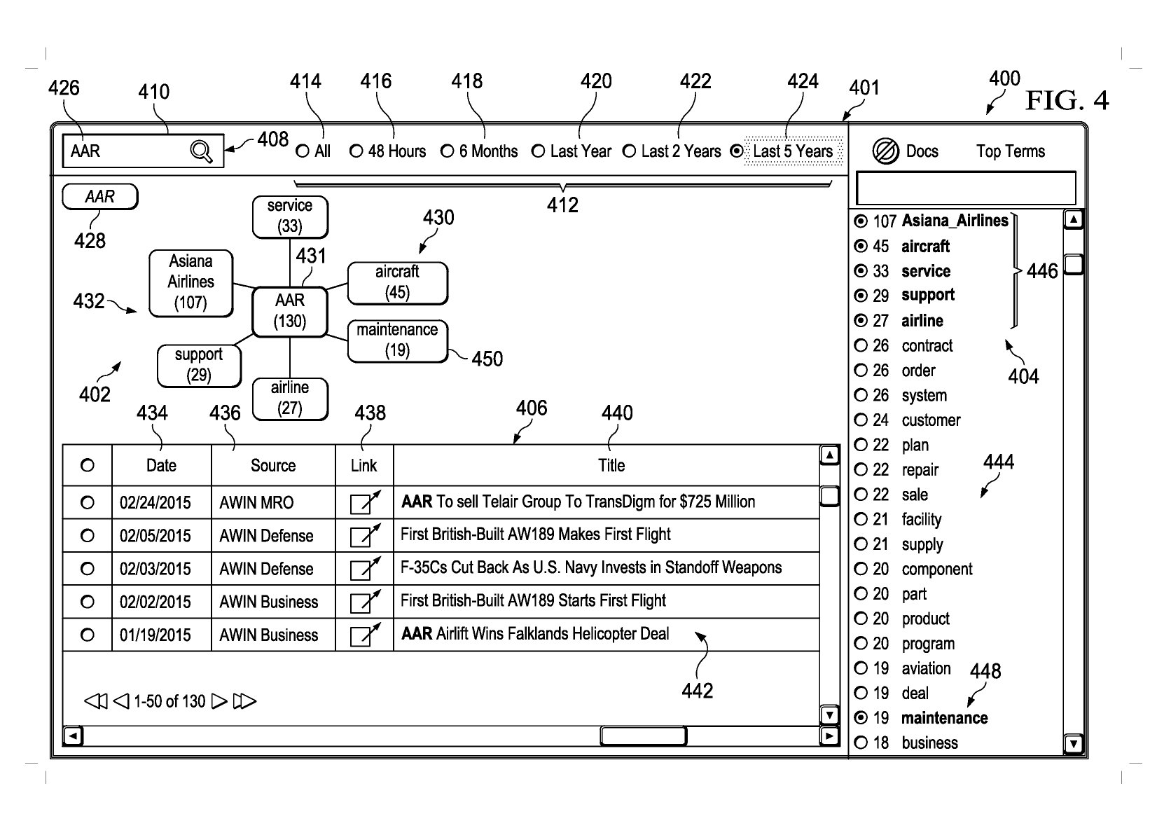

With reference now to FIG. 4, an illustration of a dive interface within a graphical user interface is depicted in accordance with an illustrative embodiment. In this illustrative example, graphical user interface 400 may be an example of one implementation for graphical user interface 112 in FIG. 1. Dive interface 401 is displayed within graphical user interface 400. Dive interface 401 may be an example of one implementation for dive interface 200 in FIG. 2.

As depicted, graphical user interface 400 includes graph area 402, selection area 404, source area 406, and input area 408. Graph area 402, selection area 404, and source area 406 may be examples of implementations for graph area 202, selection area 201, and source area 204, respectively, in FIG. 1.

In this illustrative example, a user may enter different types of user input in input area 408. Input area 408 includes entity entry box 410 and plurality of time selectors 412. Plurality of time selectors 412 include control buttons that enable a user to select the time period within which the content from various media sources is to be pulled. In this illustrative example, plurality of time selectors 412 include all button 414, 48 hours button 416, 6 months button 418, last year button 420, last 2 years button 422, and last 5 years 424 button. As depicted, last 5 years button 424 has been selected.

Entity 426 has been entered in entity entry box 410. In response to entity 426 being entered in entity entry box 410, entity identifier 428 has been added to graph area 402. Further, in response to entity 426 being entered in entity entry box 410, graph 430 is displayed in graph area 402. Graph 430 may be an example of one implementation for graph 220 in FIG. 2.

Graph 430 includes primary node 431 and set of secondary nodes 432 connected to primary node 431. Primary node 431 is visually distinguished from set of secondary nodes 432 in graphical user interface 400.

Primary node 431 identifies entity 426 and a quantity of a subset of vectors that include entity 426. This quantity of a subset of vectors may correspond directly to the quantity of media sources that have been associated with entity 426 by a vector generator, such as vector generator 116 in FIG. 1. At least a portion of these media sources may be identified within source area 406 in graphical user interface 400.

Each secondary node in set of secondary nodes 432 in graph 430 identifies a relevant entity corresponding to entity 426. Further, each secondary node identifies a quantity of vectors that include that relevant entity within the subset of vectors that includes entity 426.

Source area 406 includes date column 434, source column 436, link column 438, and title column 440, which form listing of media sources 442 through which a user may scroll. In this illustrative example, each media source included in listing of media sources 442 is an electronic media source that is available and accessible through the Internet.

In this illustrative example, date column 434 identifies the date on which each media source was published. Source column 436 identifies the publisher, business, organization, or entity that provides each media source. Link column 438 provides a hyperlink for accessing each media source. Title column 440 identifies the title of each media source. A user may sort listing of media sources 442 by date, source, or title by selecting date column 434, source column 436, or title column 440, respectively.

In response to entity 426 being entered in entity entry box 410, listing of selectable items 444 is displayed in selection area 404. Listing of selectable items 444 may be an example of one implementation for listing of selectable items 206 in FIG. 2. Listing of selectable items 444 identifies all relevant entities identified as corresponding to entity 426. These relevant entities are the other entities that are found in each vector that includes entity 426.

In this illustrative example, set of selectable items 446 have been selected. Set of secondary nodes 432 displayed in graph 430 correspond to set of selectable items 446. In other words, each secondary node in set of secondary nodes 432 is another visual representation of the relevant entity identified by a corresponding selectable item in selection area 404.

Each selectable item in listing of selectable items 444 includes an identification of the corresponding relevant entity and a quantity of vectors that include that corresponding relevant entity. For example, selectable item 448 identifies the relevant entity “maintenance” and a quantity of 19 vectors. Thus, “maintenance” appears in 19 of the media sources that also include entity 426.

The selection of selectable item 448 causes secondary node 450 to be added to graph 430. Secondary node 450 corresponds to selectable item 448, and thereby, to the relevant entity identified by selectable item 448. Similarly, a selection of some other selectable item in listing of selectable items 444 may cause a corresponding secondary node to be added to graph 430. Further, a deselection of a selectable item in listing of selectable items 444 may cause the corresponding secondary node in graph 430 to be removed from graph area 402.

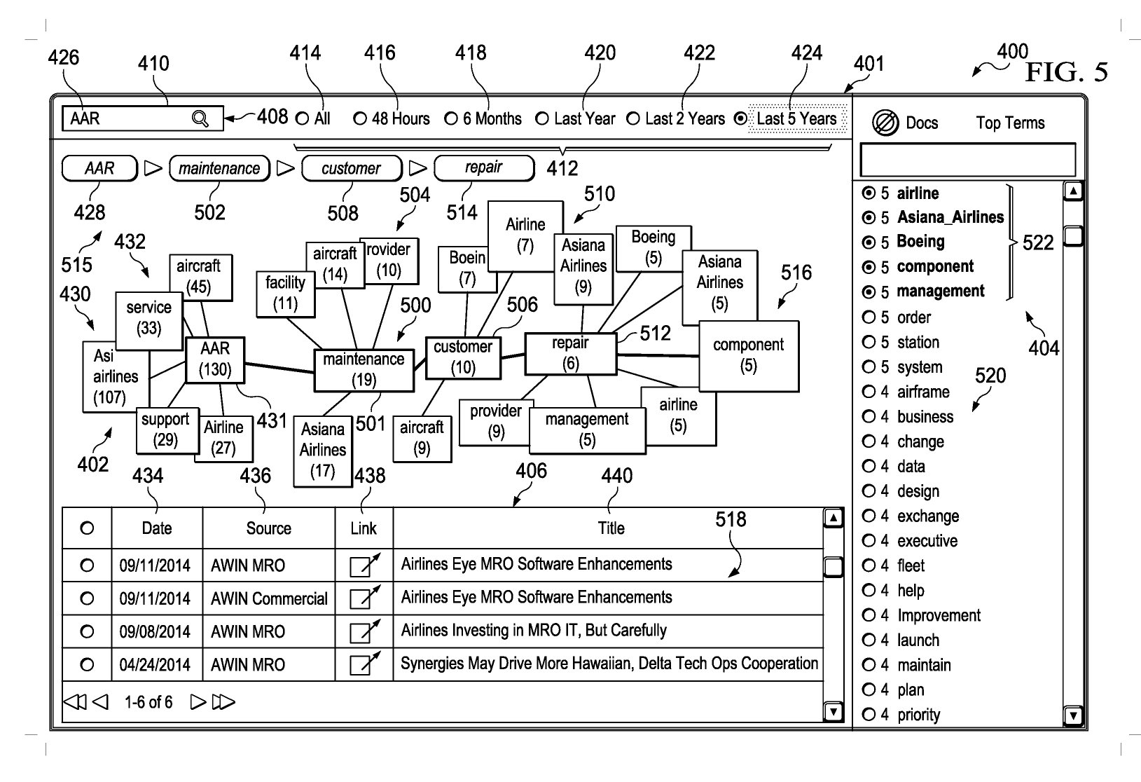

With reference now to FIG. 5, an illustration of dive interface 401 within graphical user interface 400 from FIG. 4 is depicted in accordance with an illustrative embodiment. In this illustrative example, graph 430 has been updated to form chain of primary nodes 500. Chain of primary nodes 500 may be an example of one implementation for chain of primary nodes 226 in FIG. 2.

As depicted, primary node 501 is connected to primary node 431. Primary node 501 was previously secondary node 431 in FIG. 4. A selection of secondary node 450 in FIG. 4 by user input transforms secondary node 450 in FIG. 4 into primary node 501 in FIG. 5. Further, the selection of secondary node 450 in FIG. 4 that forms a new primary node 501 in graph 430 also causes entity identifier 502 to be added to graph area 402 near entity identifier 428. Still further, set of secondary nodes 504 is added to graph 430. Each of set of secondary nodes 504 is connected to primary node 501.

User input selecting one of set of secondary nodes 504 transforms this secondary node into primary node 506. Entity identifier 508 is added to graph area 402 near entity identifier 502. Further, set of secondary nodes 510 is added to graph 430 with each of set of secondary nodes 510 connected to primary node 506.

User input selecting one of set of secondary nodes 510 transforms this secondary node into primary node 512. Entity identifier 514 is added to graph area 402 near entity identifier 508. Further, set of secondary nodes 516 is added to graph 430 with each of set of secondary nodes 516 connected to primary node 512.

In this manner, primary node 431, primary node 501, primary node 506, and primary node 512 form chain of primary nodes 500. Each of these primary nodes is displayed such that the primary nodes are easily and readily visually distinguishable from the secondary nodes in graph 430. Entity identifier 428, entity identifier 502, entity identifier 508, and entity identifier 514 form chain of identifiers 515, which corresponds to chain of primary nodes 500. Chain of identifiers 515 provides a user with a way to quickly and easily track navigation through the content visually represented within dive interface 401.

As depicted, primary node 512 identifies that only six vectors, and thereby, six media sources include all of the entities identified by the various primary nodes in chain of primary nodes 500. Six media sources may be a more manageable group than the 130 media sources that included just the entity “AAR” as identified by primary node 431.

Each new user-based selection of an entity that results in a new primary node being added to graph 430 also results in an updating of the media sources listed in source area 406. Updated listing of media sources 518 reflects the final six media sources that include all of the entities identified by chain of primary nodes 500.

Each new user-based selection of an entity that results in a new primary node being added to graph 430 also results in an updating of listing of selectable items 444 from FIG. 4. Updated listing of selectable items 520 reflects the relevant entities based on the final six media sources that include all of the entities identified by chain of primary nodes 500.

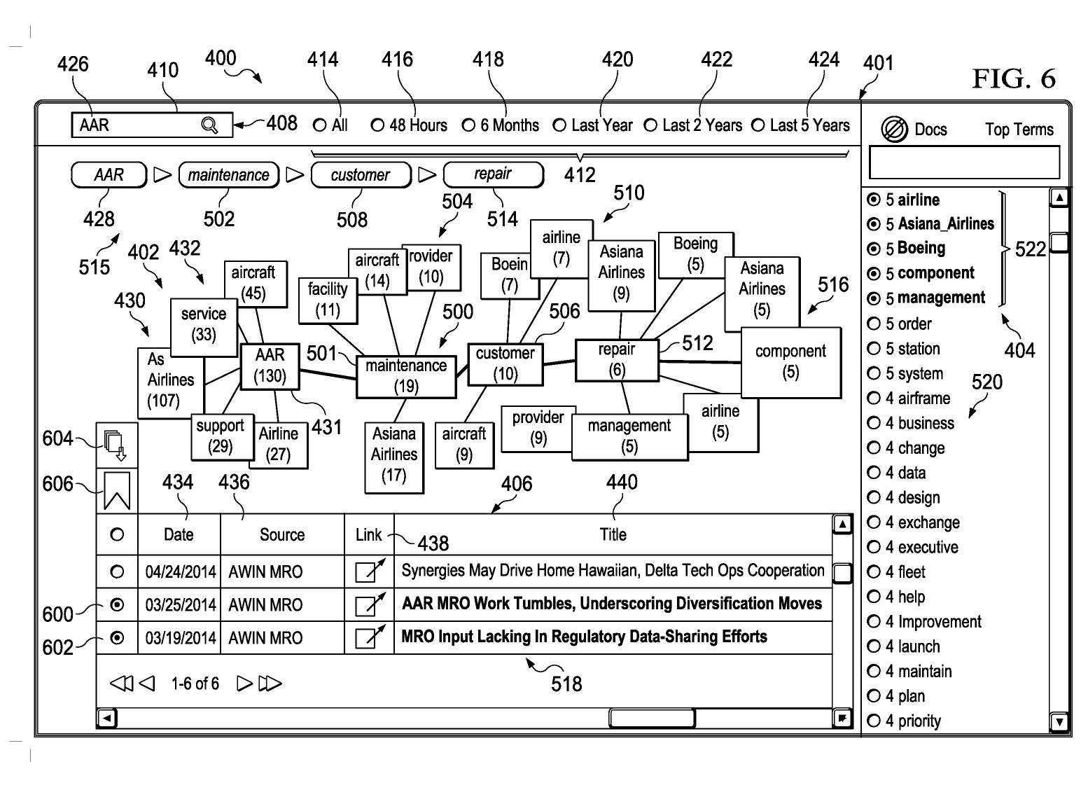

With reference now to FIG. 6, an illustration of dive interface 401 within graphical user interface 400 from FIG. 4 is depicted in accordance with an illustrative embodiment. In this illustrative example, a user has entered user input selecting media source 600 and media source 602 within updated listing of media sources 518 in source area 406.

In response to these selections, download icon 604 and tag icon 606 are displayed in graphical user interface 400. A selection of download icon 604 may enable a user to download or otherwise retrieve the actual content from the selected media sources. A selection of tag icon 606 may enable a user to share the hyperlink for and other information about the selected media sources with one or more other users.

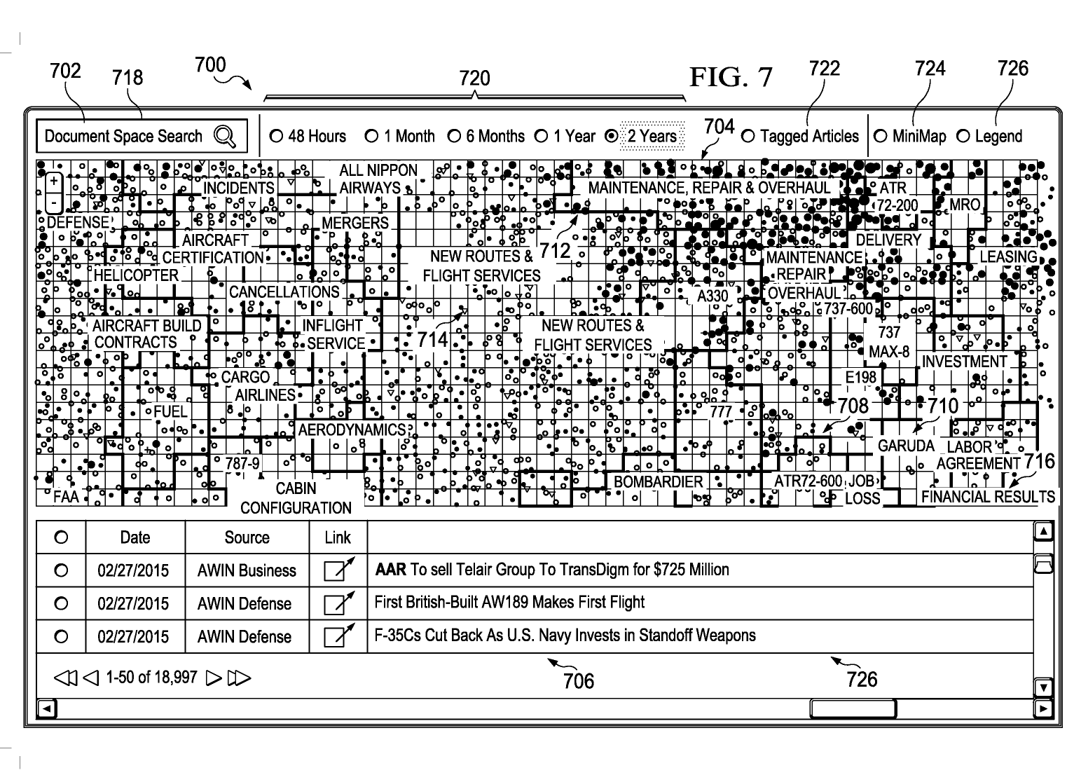

With reference now to FIG. 7, an illustration of a map environment within a graphical user interface is depicted in accordance with an illustrative embodiment. In this illustrative example, graphical user interface 700 is an example of one implementation for graphical user interface 112 in FIGS. 1 and 3.

As depicted, graphical user interface 700 includes input area 702, map area 704, and source area 706. User input may be entered through input area 702. Map area 704 is used for displaying map environment 708. In particular, map 710 is displayed within map environment 708. Map environment 708 and map 710 are examples of implementations for map environment 300 and map 302, respectively, in FIG. 3.

In this illustrative example, plurality of cluster indicators 712 and plurality of individual indicators 714 are displayed on map 710. Plurality of cluster indicators 712 and plurality of individual indicators 714 may be examples of implementations for plurality of cluster indicators 322 and plurality of individual indicators 320, respectively, in FIG. 3.

Map 710 includes plurality of concept regions 715, which may be an example of one implementation for plurality of concept regions 332 in FIG. 3. Each concept region of plurality of concept regions 715 is a region of map 710 defined by boundary lines. Each concept region represents a concept grouping and corresponds to a particular concept.

Plurality of concept labels 716 are overlaid on plurality of concept regions 715 in map 710. Plurality of concept labels 716 identify the concepts that correspond to plurality of concept regions 715. Thus, the portion of plurality of individual indicators 714 and the portion of plurality of cluster indicators 712 that are located within or on the boundary lines of a particular concept region represent media sources that are related to the corresponding concept.

Input area 702 includes concept entry box 718 and time selectors 720. Further, input area 702 includes tagged article selector 722, minimap selector 724, and legend selector 726.

Concept entry box 718 enables a user to enter a concept. An entry of a concept may cause map 710 to be zoomed in towards the particular concept region within map 710 corresponding to that concept. Time selectors 720 enable a user to select the time period for media sources to be visually represented within map 710.

A selection of tagged article selector 722 causes only those media sources that have been previously tagged to be displayed in map 710. A tagged article may be a media source that has been shared with another user. A selection of minimap selector 724 causes a miniature zoomed out view of map 710 to be displayed in graphical user interface 700. A selection of legend selector 726 causes a legend to be displayed in graphical user interface 700 for use in interpreting the graphical indicators displayed on map 710.

Listing of media sources 728 in source area 706 provides the user with a more detailed view of the individual media sources visually represented within map 710. The user may scroll through the listing of media sources 728 and select any media source of interest within this listing of media sources 728 to tag that media source, download that media source, or perform some other operation related to that media source.

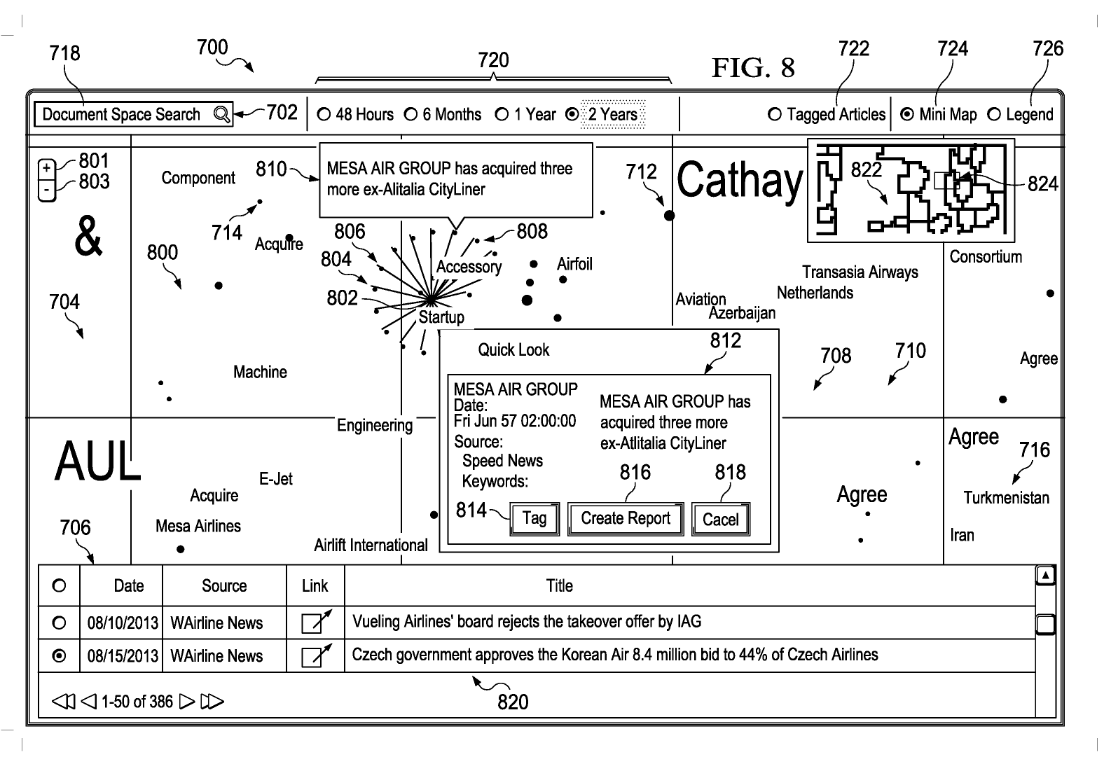

With reference now to FIG. 8, an illustration of a zoomed in view of map 710 from FIG. 7 is depicted in accordance with an illustrative embodiment. In this illustrative example, zoomed in view 800 of map 710 is displayed in graphical user interface 700. A user may use zoom in control 801 to provide zoom in input for zooming into map 710. A user may use zoom out control 703 to provide zoom out input for zooming out of map 710.

In this illustrative example, cluster indicator 802 has been selected through user input. Consequently, cluster indicator 802 has been exploded out such that the visual representation of the cluster of media sources represented by cluster indicator 802 is transformed into a visual representation of the individual media sources within that cluster. In particular, cluster indicator 802 has been exploded into group of individual indicators 804. In this illustrative example, group of individual indicators 804 are shown connected to cluster indicator 802 and displayed according to spiral pattern 806.

Individual indicator 808 belongs to group of individual indicators 804. A selection of individual indicator 808 through user input causes information feature 810 to be displayed in graphical user interface 700. Information feature 810 identifies information about the media source represented by individual indicator 808.

A selection of information feature 810 causes option box 812 to be displayed. Option box 812 also identifies information about the media source represented by individual indicator 808. Further, option box 812 includes tag button 814, report button 816, and cancel button 818. Selecting tag button 814 enables sharing of the media source represented by individual indicator 808 with another user. Selecting report button 816 causes a report to be generated with the information about the media source represented by individual indicator 808. Selecting cancel button 818 may remove option box 812 from graphical user interface 700.

In this illustrative example, updated listing of media sources 820 in source area 706 includes a list of all media sources represented by the indicators displayed in zoomed in view 800 of map 710. Updated listing of media source 820 includes significantly fewer media sources than listing of media sources 728 in FIG. 7.

In this illustrative example, minimap 822 is displayed in graphical user interface 700. Minimap 822 is a miniature zoomed out view of the entirety of map 710. Area 824 in minimap 822 indicates the portion of map 710 that is currently displayed in graphical user interface 700 based on the current zoom level.

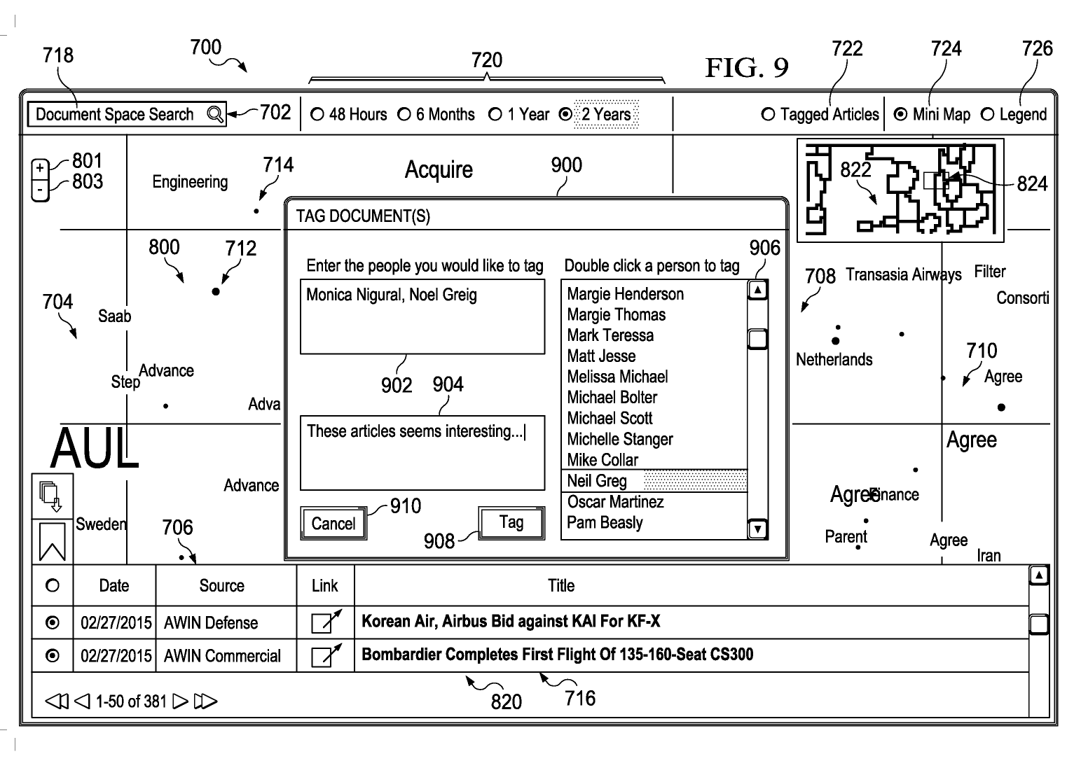

With reference now to FIG. 9, an illustration of a tag window displayed in graphical user interface 700 from FIG. 8 is depicted in accordance with an illustrative embodiment. In this illustrative example, tag window 900 may be displayed in graphical user interface 700 from FIG. 8 when tag button 814 in FIG. 8 is selected.

As depicted, tag window 900 includes people entry box 902, notes entry box 904, people option box 906, tag button 908, and cancel button 910. People entry box 902 enables a user to directly enter the names or identifiers of users with whom the media source is to be shared. In this illustrative example, tagging a person may cause the digital document of the media source or a hyperlink for the media source to be emailed to that person.

Notes entry box 904 enables a user to enter notes or comments to be included with the email. People option box 906 enables a user to select from a predefined listing of users.

A selection of tag button 908 causes the media source to be shared with any person that has been identified in people entry box 902 and any person that has been selected through people option box 906. A selection of cancel button 910 closes tag window 900.

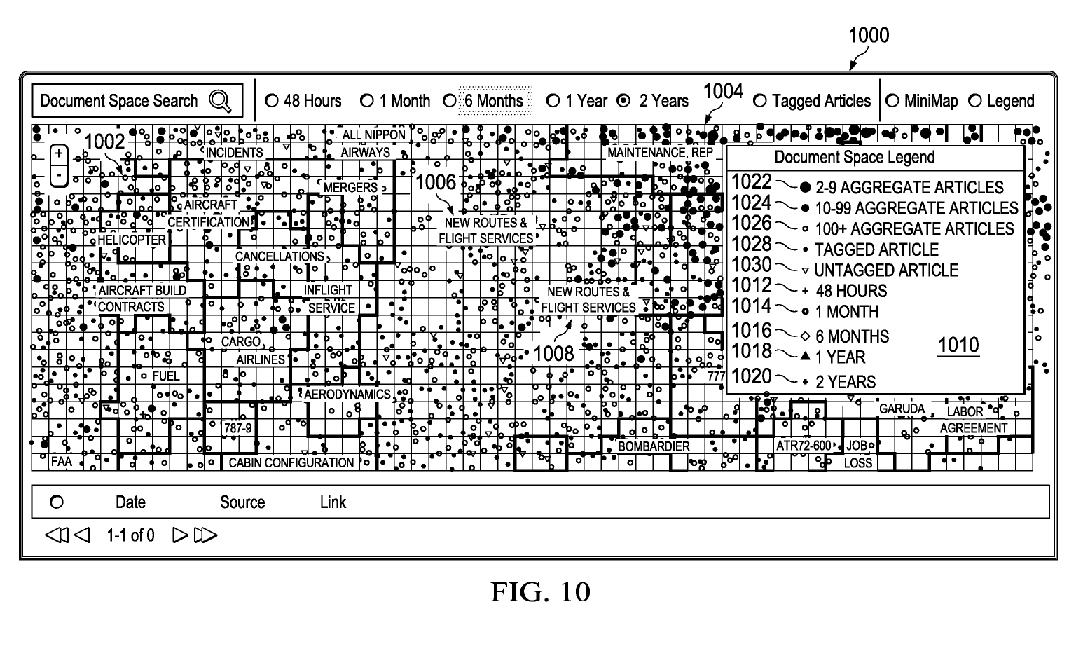

With reference now to FIG. 10, an illustration of a map environment in a graphical user interface is depicted in accordance with an illustrative embodiment. In this illustrative example, graphical user interface 1000 is another example of one implementation for graphical user interface 112 described in FIG. 3.

In this illustrative example, map environment 1002 in graphical user interface 1000 includes map 1004. Plurality of graphical indicators 1006 and plurality of concept labels 1008 are displayed on map 1004.

In this illustrative example, legend 1010 is also displayed in graphical user interface 1000. Legend 1010 identifies first time type 1012, second time type 1014, third time type 1016, fourth time type 1018, and fifth time type 1020.

First time type 1012, second time type 1014, third time type 1016, fourth time type 1018, and fifth time type 1020 correspond to times periods of 48 hours, 1 month, 6 months, 1 year, and 2 years, respectively. A graphical indicator having a time type selected from one of first time type 1012, second time type 1014, third time type 1016, fourth time type 1018, or fifth time type 1020 means that the media source or media sources represented by that graphical indicator was published or made publicly available within the corresponding time period.

Legend 1010 also identifies first quantity type 1022, second quantity type 1024, and third quantity type 1026 for describing cluster indicators. Each of these quantity types corresponds with a different number of media sources. For example, a cluster indicator of first quantity type 1022, second quantity type 1024, or third quantity 1026 represents a cluster of nodes, and thereby, a cluster of media sources that includes 2 to 9 media sources, 10 to 99 media sources, or 100 or more media sources, respectively.

Legend 1010 also identifies tagged type 1028 and untagged type 1030. A graphical indicator of tagged type 1028 indicates that the corresponding media source was tagged. A graphical indicator of untagged type 1030 indicates that the corresponding media source has never been tagged.

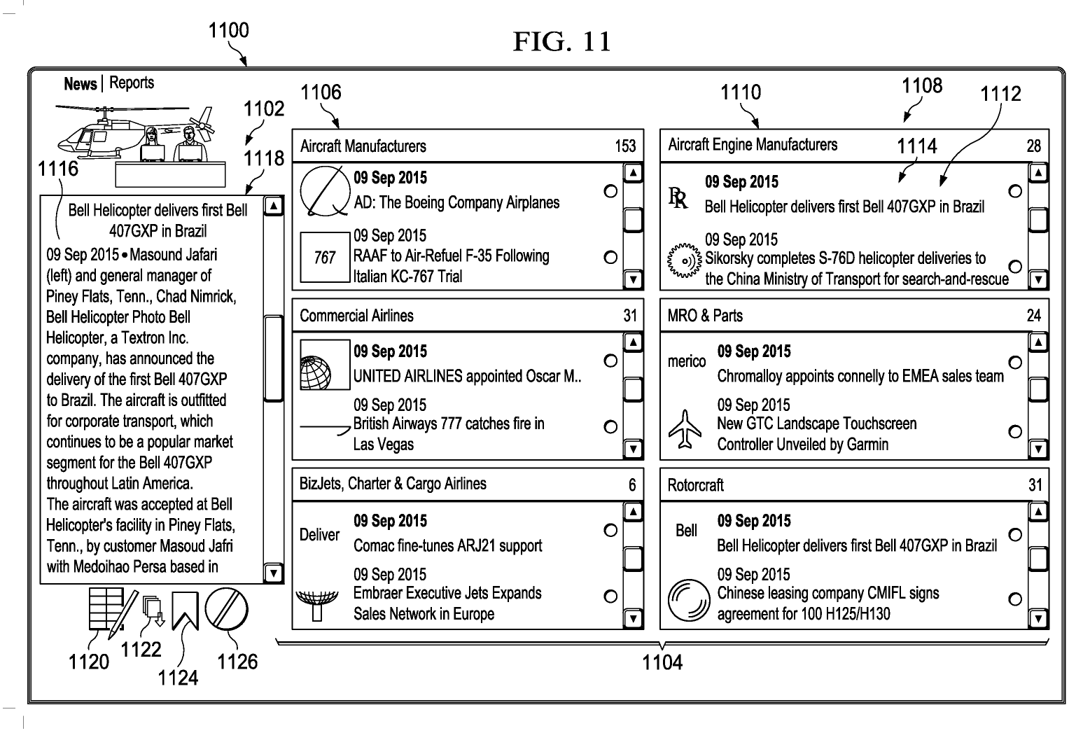

With reference now to FIG. 11, an illustration of a dashboard is depicted in accordance with an illustrative embodiment. In this illustrative example, dashboard 1100 is an example of one implementation for dashboard 146 in FIG. 1.

Dashboard 1100 includes featured area 1102 and topic area 1104. In this illustrative example, plurality of topic boxes 1106 are displayed within topic area 1104. A dashboard manager, such as dashboard manager 121 in FIG. 1, pushes highlights corresponding to media sources related to a topic corresponding to a particular topic box for display within that topic box.

As one illustrative example, topic box 1108 includes topic information 1110 and plurality of highlights 1112. Topic information 1110 identifies the corresponding topic and the number of media sources having highlights included within topic box 1108.

Each highlight in plurality of highlights 1112 may be a notification, a snapshot, a status update, or some other type of information related to a corresponding media source. Highlight 1114 is an example of one of plurality of highlights 1112. A selection of highlight 1114 by user input causes the corresponding media source to be displayed within featured area 1102. As depicted, content 1116 for media source 1118 is displayed within featured area 1102.

Dashboard 1100 also includes customization button 1120, report button 1122, tag button 1124, and close button 1126. Selecting customization button 1120 allows a user to customize dashboard 1100. Selecting report button 1122 allows a user to generate a report that includes content 1116. Selecting tag button 1124 allows a user to share media source 1118 with another user. Selecting close button 1126 allows a user to remove the display of media source 1118 from featured area 1102 or to remove featured area 1102 from dashboard 1100.

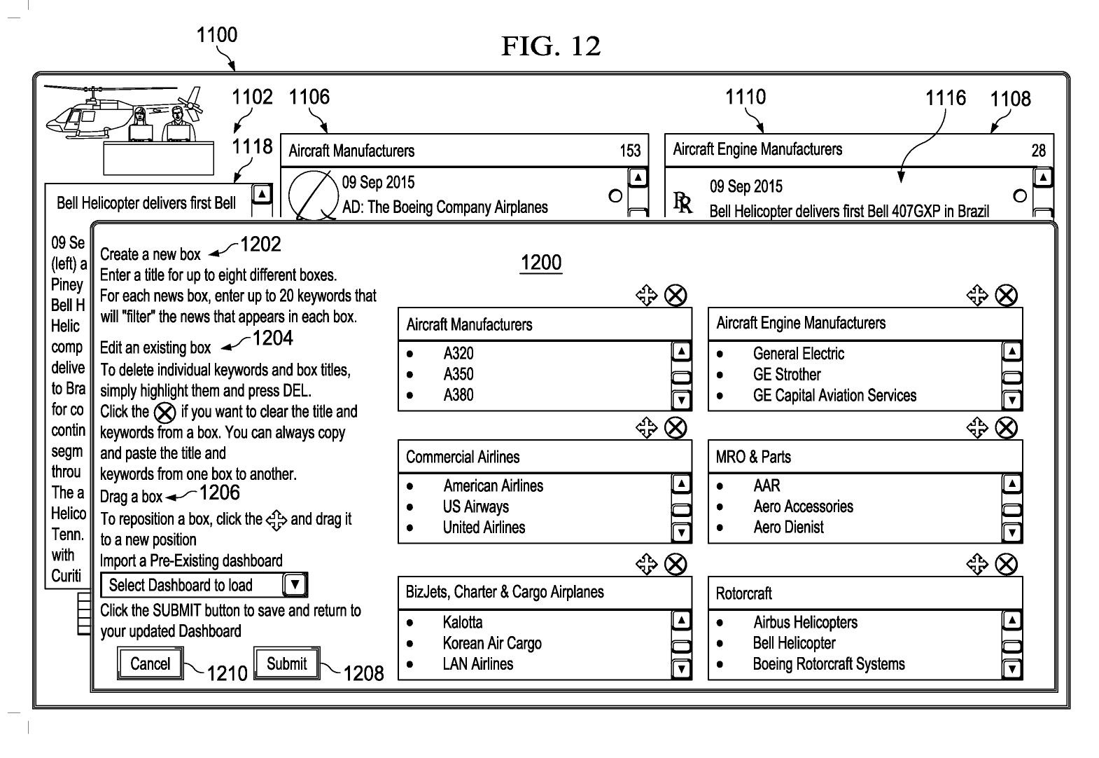

With reference now to FIG. 12, an illustration of a customization window displayed over a dashboard is depicted in accordance with an illustrative embodiment. In this illustrative example, a selection of customization button 1120 in FIG. 11 has caused customization window 1200 to be displayed over dashboard 1100 from FIG. 11.

Customization window 1200 includes new topic box section 1202, edit topic box section 1204, positioning section 1206, submit button 1208, and cancel button 1210. New topic box section 1202 instructs a user on how to add a new topic box to topic area 1104 in dashboard 1100 in FIG. 11. Edit topic box section 1204 instructs a user on how to edit an existing topic box in topic area 1104 in dashboard 1100. Further, positioning section 1206 instructs a user on how to reposition the topic boxes within topic area 1104 of dashboard 1100.

Selecting submit button 1208 causes any customization changes made to be applied. Selecting cancel button 1210 closes customization window 1200 without saving any changes.

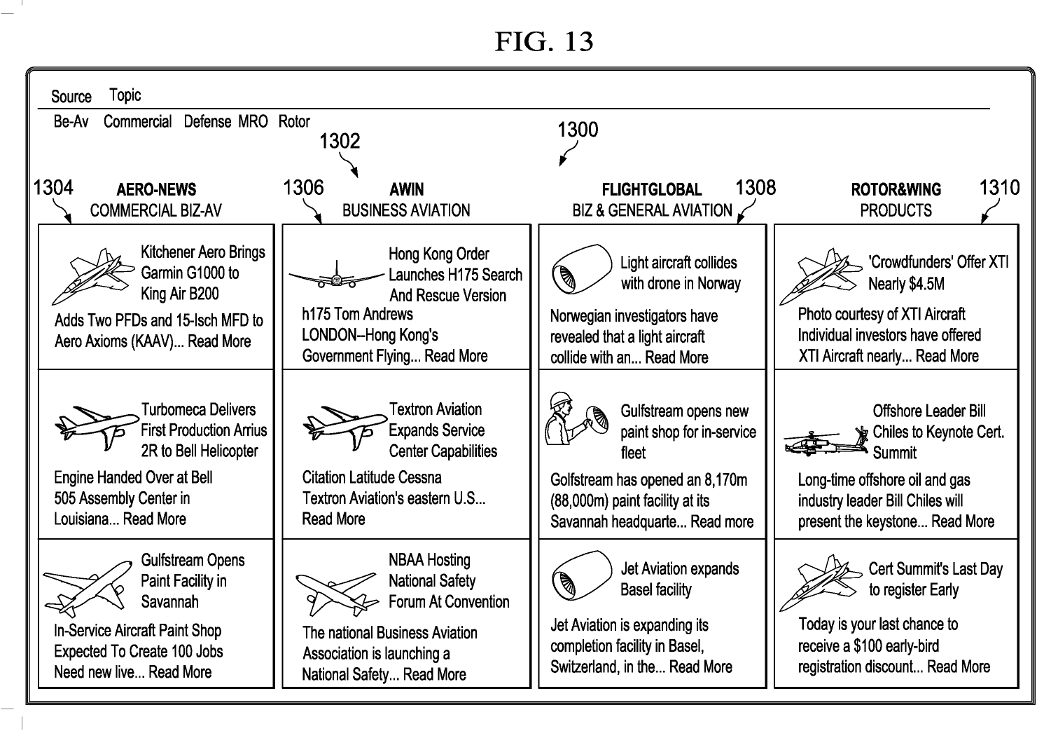

With reference now to FIG. 13, an illustration of a dashboard is depicted in accordance with an illustrative embodiment. In this illustrative example, dashboard 1300 is another example of one implementation for dashboard 146 in FIG. 1.

In this illustrative example, dashboard 1300 includes plurality of topic sections 1302. Plurality of topic sections 1302 include topic section 1304, topic section 1306, topic section 1308, and topic section 1310. Each of these topic sections may display highlights for media sources that are relevant to the topics identified by these topic sections.

The illustrations of graphical user interfaces in FIGS. 4-13 are not meant to imply physical or architectural limitations to the manner in which an illustrative embodiment may be implemented. Other elements in addition to or in place of the ones illustrated may be used. Some elements may be optional.

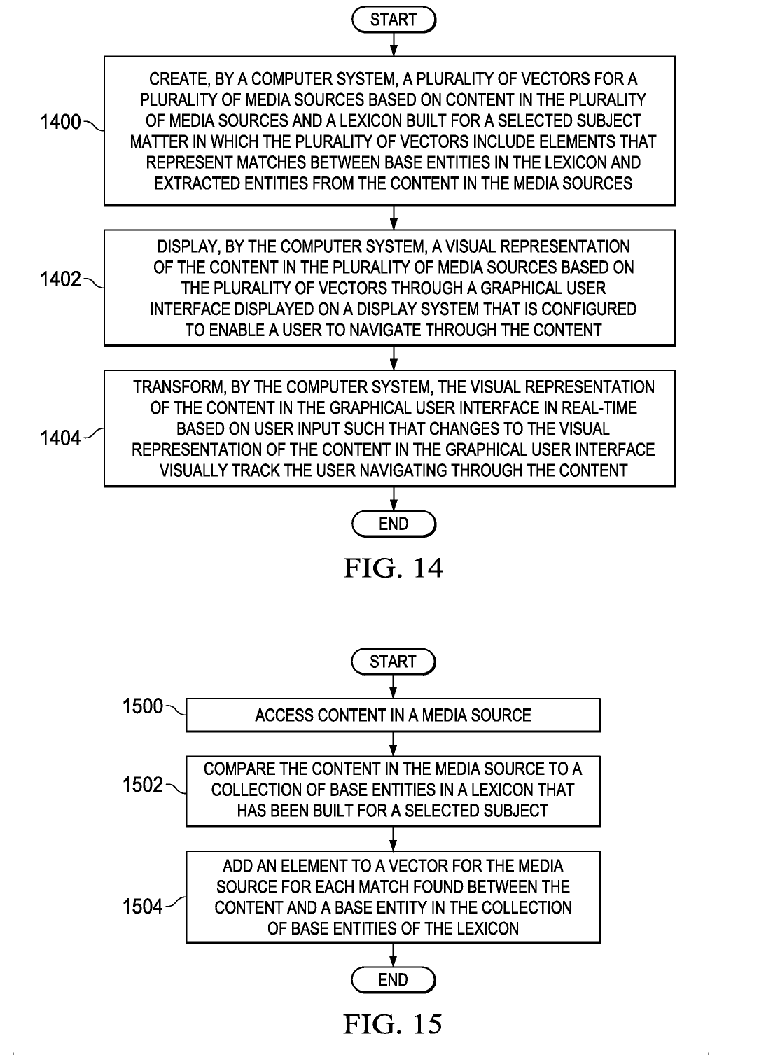

With reference now to FIG. 14, an illustration of a process for visually representing information is depicted in the form of a flowchart in accordance with an illustrative embodiment. The process illustrated in FIG. 14 may be implemented using content management system 100 in FIG. 1. In one illustrative example, the process illustrated in FIG. 14 may be implemented using vector generator 116 from FIG. 1 and content diver 118, map manager 120, or both from FIG. 1.

The process begins by creating, by a computer system, a plurality of vectors for a plurality of media sources based on content in the plurality of media sources and a lexicon built for a selected subject matter in which the plurality of vectors include elements that represent matches between base entities in the lexicon and extracted entities from the content in the media sources (operation 1400). In operation 1400, the lexicon may include a collection of base entities. Next, the computer system displays a visual representation of the content in the plurality of media sources based on the plurality of vectors through a graphical user interface displayed on a display system that is configured to enable a user to navigate through the content (operation 1402).

Thereafter, the computer system may transform the visual representation of the content in the graphical user interface in real-time based on user input such that changes to the visual representation of the content in the graphical user interface visually track the user navigating through the content (operation 1404), with the process terminating thereafter. In operation 1404, this transformation may be performed in a manner that allows a user to further navigate through the content quickly and easily. Transforming the visual representation in real-time may mean transforming the visual representation without significant delay or without an observable delay from the time the user input is received through the graphical user interface.

With reference now to FIG. 15, an illustration of a process for creating a vector for a media source is depicted in the form of a flowchart in accordance with an illustrative embodiment. The process illustrated in FIG. 15 may be implemented using vector generator 116 from FIG. 1. Further, this process may be used to implement operation 1400 in FIG. 14.

The process may begin by accessing content in a media source (operation 1500). Next, the content in the media source is compared to a collection of base entities in a lexicon that has been built for a selected subject (operation 1502).

Operation 1502 may be performed by, for example, without limitation, parsing the content in the media source to form a plurality of extracted entities. Each extracted entity in the plurality of extracted entities may be compared to the collection of base entities to determine whether a match is present between that extracted entity and any base entity in the collection of base entities.

An element is added to a vector for the media source for each match found between the content and a base entity in the collection of base entities of the lexicon (operation 1504), with the process terminating thereafter. The process described in FIG. 15 may be repeated for each media source in a plurality of media sources.

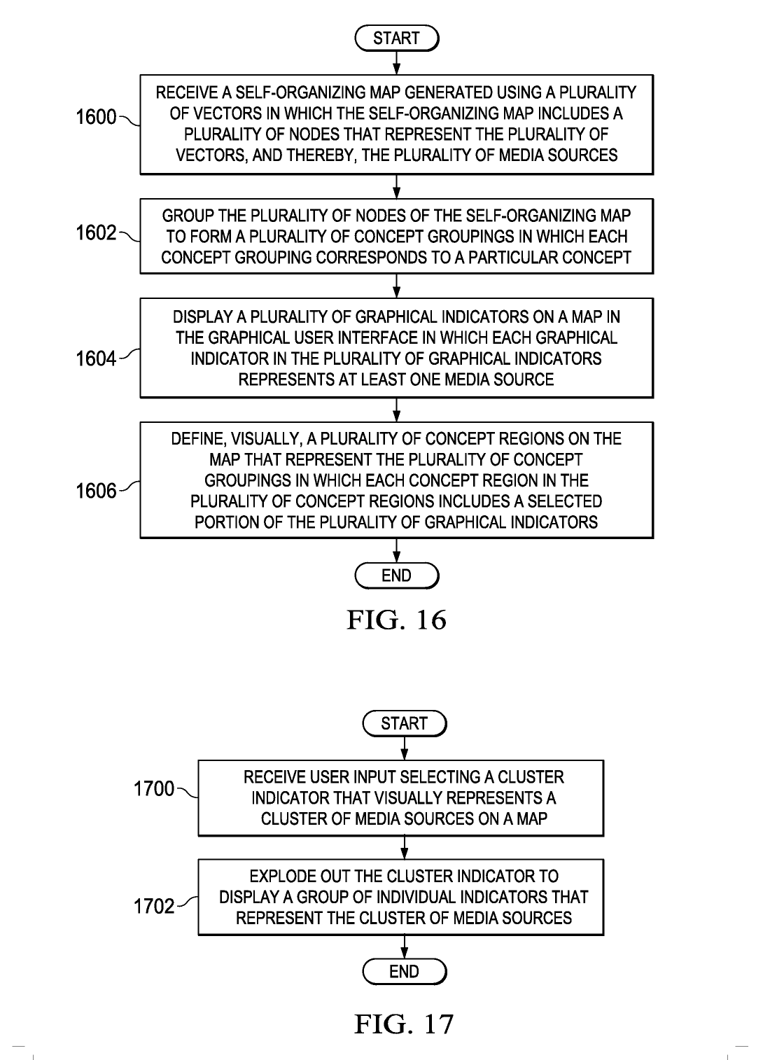

With reference now to FIG. 16, an illustration of a process for displaying a visual representation of content in a plurality of media sources is depicted in the form of a flowchart in accordance with an illustrative embodiment. The process illustrated in FIG. 16 may be implemented using map manager 120 in FIGS. 1 and 3.

The process may begin by receiving a self-organizing map generated using a plurality of vectors in which the self-organizing map includes a plurality of nodes that represent a plurality of vectors, and thereby, a plurality of media sources (operation 1600). In one illustrative example, the self-organizing map may be self-organizing map 310 generated by self-organizing map generator 306 in FIG. 3. The plurality of nodes of the self-organizing map are grouped to form a plurality of concept groupings in which each concept grouping corresponds to a particular concept (operation 1602).

A plurality of graphical indicators are displayed on a map in the graphical user interface in which each graphical indicator in the plurality of graphical indicators represents at least one media source (operation 1604). In operation 1604, the plurality of graphical indicators may include cluster indicators based on the zoom level of the map.

A plurality of concept regions that represent the plurality of concept groupings are visually defined on the map in which each concept region includes a selected portion of the plurality of graphical indicators (operation 1606), with the process terminating thereafter. Each concept region in operation 1606 may be visually defined by, for example, without limitation, graphical boundary lines. A concept region may share one or more graphical indicators with another concept region, in some illustrative examples.

With reference now to FIG. 17, an illustration of a process for transforming a visual representation of content in a graphical user interface is depicted in the form of a flowchart in accordance with an illustrative embodiment. The process illustrated in FIG. 17 may be implemented using map manager 120 in FIGS. 1 and 3.

The process begins by receiving user input selecting a cluster indicator that visually represents a cluster of media sources on a map (operation 1700). In response to receiving this selection, the cluster indicator is exploded out to display a group of individual indicators that represent the cluster of media sources (operation 1702), with the process terminating thereafter.

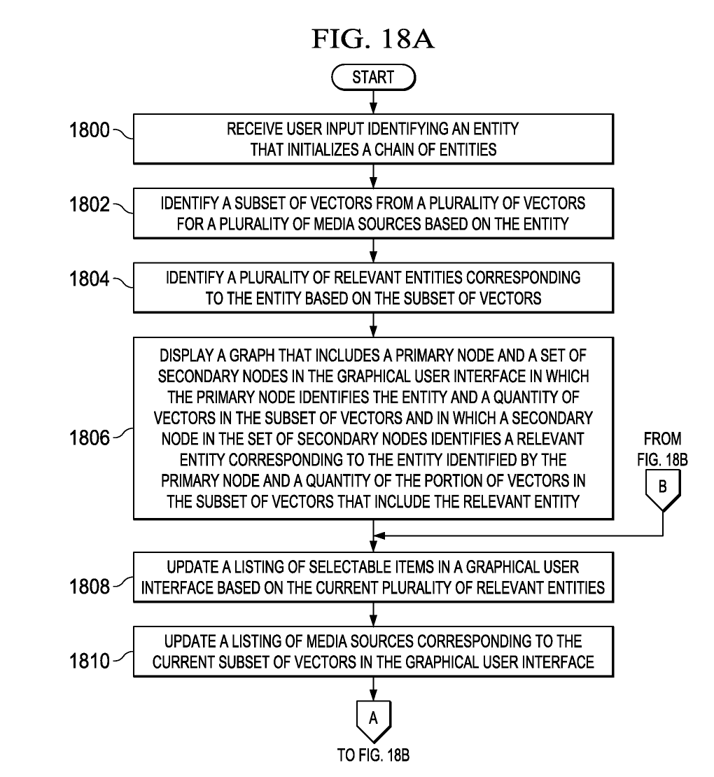

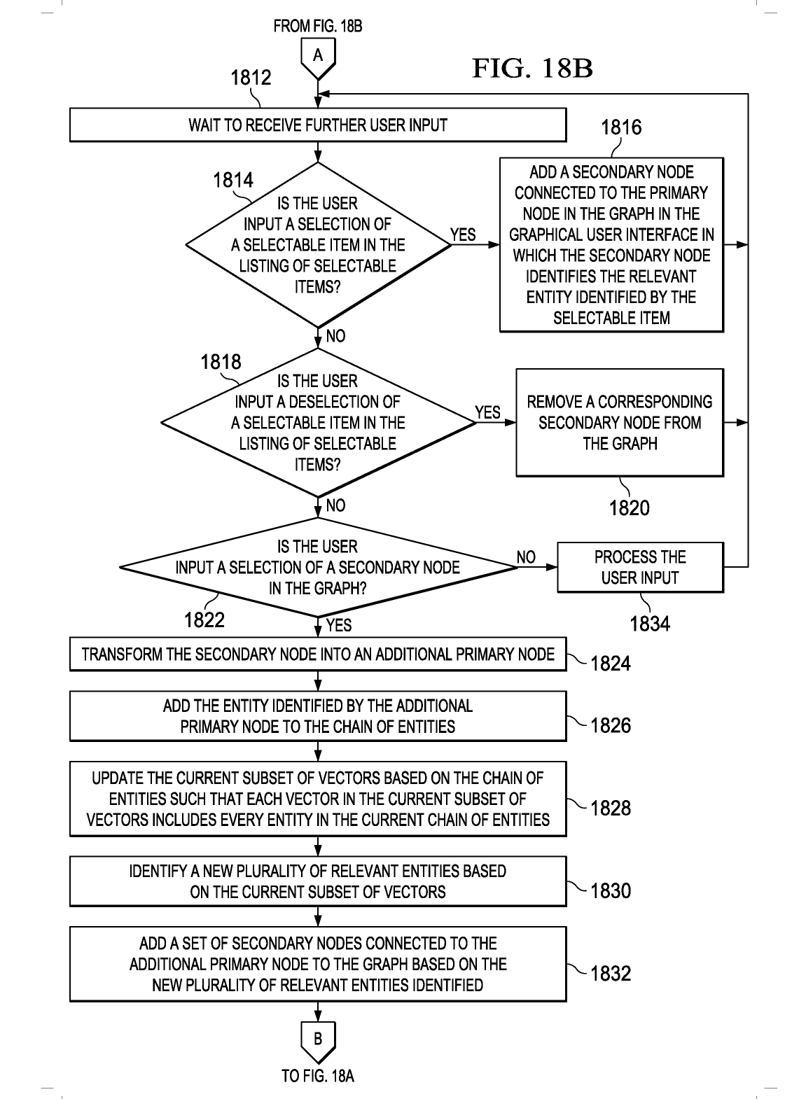

With reference now to FIGS. 18A and 18B, illustrations of a process for facilitating user-driven navigation through content in a plurality of media sources is depicted in the form of a flowchart in accordance with an illustrative embodiment. The process illustrated in FIGS. 18A and 18B may be implemented using content diver 118 in FIGS. 1-2.

The process begins by receiving user input identifying an entity that initializes a chain of entities (operation 1800). A subset of vectors are identified from a plurality of vectors for a plurality of media sources based on the entity (operation 1802). Next, a plurality of relevant entities corresponding to the entity are identified based on the subset of vectors (operation 1804). In operation 1804, the plurality of relevant entities may include all other distinct entities in the subset of vectors.

A graph that includes a primary node and a set of secondary nodes is displayed in the graphical user interface in which the primary node identifies the entity and a quantity of vectors in the subset of vectors and in which a secondary node in the set of secondary nodes identifies a relevant entity corresponding to the entity identified by the primary node and a quantity of the portion of vectors in the subset of vectors that include the relevant entity (operation 1806). In operation 1806, the primary node may be an initial primary node in a chain of primary nodes.

A listing of selectable items is updated in a graphical user interface based on the current plurality of relevant entities (operation 1808). In operation 1808, this updating may include the first display of this listing of selectable items. Further, in operation 1808, each selectable item in the listing of selectable items identifies a corresponding relevant entity.

A listing of media sources corresponding to the current subset of vectors is updated in the graphical user interface (operation 1810). In operation 1810, this updating may include the first display of this listing of media sources.

Thereafter, the process waits to receive further user input (operation 1812). A determination is made as to whether the user input is a selection of a selectable item in the listing of selectable items (operation 1814). If the selection is of a selectable item in the listing of selectable items, the process adds a secondary node connected to the primary node in the graph in the graphical user interface in which the secondary node identifies the relevant entity identified by the selectable item (operation 1816). The process then returns to operation 1812.

With reference again to operation 1814, if the selection is not of a selectable item in the listing of selectable items, a determination is made as to whether the user input is a deselection of a selectable item in the listing of selectable items (operation 1818). If the user input is a deselection, the process removes a corresponding secondary node from the graph (operation 1820), with the process then returning to operation 1812.

Otherwise, if the user input is not a deselection, the process determines whether the user input is a selection of a secondary node in the graph (operation 1822). If the user input is a selection of a secondary node in the graph, the secondary node is transformed into an additional primary node (operation 1824). In operation 1824, this additional primary node is added to the chain of primary nodes in the graph. The entity identified by the additional primary node is added to the chain of entities (operation 1826).

Thereafter, the current subset of vectors is updated based on the chain of entities such that each vector in the current subset of vectors includes every entity in the current chain of entities (operation 1828). A new plurality of relevant entities is identified based on the current subset of vectors (operation 1830). A set of secondary nodes connected to the additional primary node is added to the graph based on the new plurality of relevant entities identified (operation 1832), with the process retuning to operation 1808 described above.

With reference again to operation 1822, if the user input is not a selection of a secondary node, the process otherwise processes the user input (operation 1834) and proceeds to operation 1812 described above. In some cases, the user input may indicate that the process of navigating through the content in the media sources is to be terminated. In these particular cases, processing the user input terminates the overall process in FIGS. 18A and 18B.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

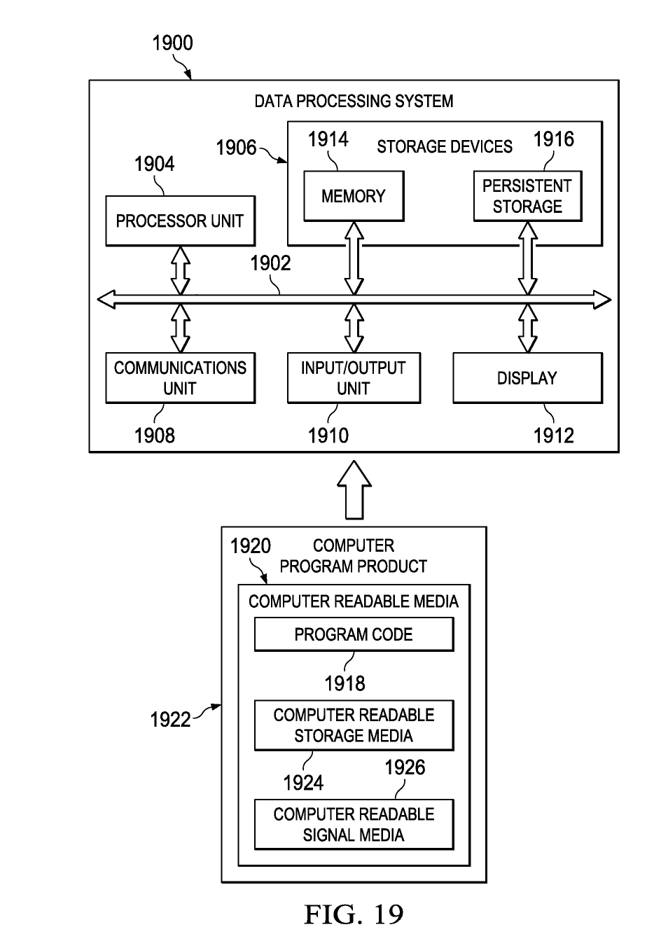

Turning now to FIG. 19, an illustration of a data processing system in the form of a block diagram is depicted in accordance with an illustrative embodiment. Data processing system 1900 may be used to implement computer system 102 in FIG. 1. As depicted, data processing system 1900 includes communications framework 1902, which provides communications between processor unit 1904, storage devices 1906, communications unit 1908, input/output unit 1910, and display 1912. In some cases, communications framework 1902 may be implemented as a bus system.

Processor unit 1904 is configured to execute instructions for software to perform a number of operations. Processor unit 1904 may comprise a number of processors, a multi-processor core, and/or some other type of processor, depending on the implementation. In some cases, processor unit 1904 may take the form of a hardware unit, such as a circuit system, an application specific integrated circuit (ASIC), a programmable logic device, or some other suitable type of hardware unit.

Instructions for the operating system, applications, and/or programs run by processor unit 1904 may be located in storage devices 1906. Storage devices 1906 may be in communication with processor unit 1904 through communications framework 1902. As used herein, a storage device, also referred to as a computer readable storage device, is any piece of hardware capable of storing information on a temporary and/or permanent basis. This information may include, but is not limited to, data, program code, and/or other information.

Memory 1914 and persistent storage 1916 are examples of storage devices 1906. Memory 1914 may take the form of, for example, a random access memory or some type of volatile or non-volatile storage device. Persistent storage 1916 may comprise any number of components or devices. For example, persistent storage 1916 may comprise a hard drive, a flash memory, a rewritable optical disk, a rewritable magnetic tape, or some combination of the above. The media used by persistent storage 1916 may or may not be removable.

Communications unit 1908 allows data processing system 1900 to communicate with other data processing systems and/or devices. Communications unit 1908 may provide communications using physical and/or wireless communications links.

Input/output unit 1910 allows input to be received from and output to be sent to other devices connected to data processing system 1900. For example, input/output unit 1910 may allow user input to be received through a keyboard, a mouse, and/or some other type of input device. As another example, input/output unit 1910 may allow output to be sent to a printer connected to data processing system 1900.

Display 1912 is configured to display information to a user. Display 1912 may comprise, for example, without limitation, a monitor, a touch screen, a laser display, a holographic display, a virtual display device, and/or some other type of display device.

In this illustrative example, the processes of the different illustrative embodiments may be performed by processor unit 1904 using computer-implemented instructions. These instructions may be referred to as program code, computer usable program code, or computer readable program code and may be read and executed by one or more processors in processor unit 1904.

In these examples, program code 1918 is located in a functional form on computer readable media 1920, which is selectively removable, and may be loaded onto or transferred to data processing system 1900 for execution by processor unit 1904. Program code 1918 and computer readable media 1920 together form computer program product 1922. In this illustrative example, computer readable media 1920 may be computer readable storage media 1924 or computer readable signal media 1926.

Computer readable storage media 1924 is a physical or tangible storage device used to store program code 1918 rather than a medium that propagates or transmits program code 1918. Computer readable storage media 1924 may be, for example, without limitation, an optical or magnetic disk or a persistent storage device that is connected to data processing system 1900.

Alternatively, program code 1918 may be transferred to data processing system 1900 using computer readable signal media 1926. Computer readable signal media 1926 may be, for example, a propagated data signal containing program code 1918. This data signal may be an electromagnetic signal, an optical signal, and/or some other type of signal that can be transmitted over physical and/or wireless communications links.

The illustration of data processing system 1900 in FIG. 19 is not meant to provide architectural limitations to the manner in which the illustrative embodiments may be implemented. The different illustrative embodiments may be implemented in a data processing system that includes components in addition to or in place of those illustrated for data processing system 1900. Further, components shown in FIG. 19 may be varied from the illustrative examples shown.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a display module that is implemented in a computer system and configured to display a graphical user interface;
a vector generator module that is implemented in the computer system and configured to generate a plurality of vectors for a plurality of media sources based on content in the plurality of media sources and a lexicon that is built for a selected subject,
wherein the plurality of vectors include elements that represent matches between base entities in the lexicon and extracted entities from the content in the plurality of media sources; and
a visualizer module that is implemented in the computer system, coupled to the vector generator module and the display module, and configured to display a visual representation of the content in the plurality of media sources in the graphical user interface,
wherein the plurality of vectors and the graphical user interface are configured to enable a user to navigate through the content; and
wherein the visualizer module is further configured to visually transform the visual representation of the content in the graphical user interface in real-time based on user input.

2. The apparatus of claim 1, wherein an element in a vector in the plurality of vectors for a corresponding media source in the plurality of media sources represents a match between an extracted entity from the corresponding media source and a base entity in the lexicon.

3. The apparatus of claim 1, wherein the graphical user interface comprises:
a graph area for visually presenting a graph that includes a primary node, wherein the primary node identifies a base entity and a quantity for a subset of vectors in the plurality of vectors that include the base entity.

4. The apparatus of claim 3, wherein the graph further includes a set of secondary nodes, wherein a secondary node in the set of secondary nodes identifies a relevant entity corresponding to the base entity identified by the primary node and a quantity of a portion of vectors in the subset of vectors that include the relevant entity.

5. The apparatus of claim 1, wherein the graphical user interface comprises:
a selection area for displaying a listing of selectable items, wherein a selection of a selectable item modifies a graph displayed in a graph area of the graphical user interface.

6. A computer-implemented electronic media content navigation system comprising:
a display module that is implemented in a computer system and configured to display a graphical user interface;
a data structure storing a lexicon that is built for a selected subject;
a vector generator module that is implemented in the computer system and configured to access a plurality of media sources through a computer network and generate a plurality of vectors for the plurality of media sources based on the lexicon and content in the plurality of media sources,
wherein the plurality of vectors include elements that represent matches between base entities in the lexicon and extracted entities from the content in the plurality of media sources; and
a visualizer module that is implemented in the computer system, coupled to the vector generator module and the display module, and configured to display a visual representation of the content in the plurality of media sources in the graphical user interface,
wherein the plurality of vectors and the graphical user interface are configured to enable a user to navigate through the content; and
wherein the visualizer module is further configured to visually transform the visual representation of the content in the graphical user interface in real-time based on user input.

7. A method for visually representing content in a plurality of media sources, the method comprising:
creating, by a computer system, a plurality of vectors for the plurality of media sources based on content in the plurality of media sources and a lexicon built for a selected subject, wherein the plurality of vectors include elements that represent matches between base entities in the lexicon and extracted entities from the content in the plurality of media sources;
displaying, by the computer system, a visual representation of the content in the plurality of media sources based on the plurality of vectors through a graphical user interface that is configured to enable a user to navigate through the content; and
transforming, by the computer system, the visual representation of the content in the graphical user interface in real-time based on user input such that changes to the visual representation of the content in the graphical user interface visually track the user navigating through the content.

8. The method of claim 7, wherein creating, by the computer system, the plurality of vectors comprises:
comparing the content in a media source to a collection of base entities in the lexicon; and
adding an element to a vector for the media source for each match found between the content and a base entity in the collection of base entities in the lexicon.

9. The method of claim 8, wherein comparing the content in the media source to the collection of base entities comprises:
extracting a plurality of extracted entities from the media sources; and
comparing an extracted entity in the plurality of extracted entities to the collection of base entities to determine whether a match is present between the extracted entity and any base entity in the collection of base entities.

10. The method of claim 7, wherein displaying, by the computer system, the visual representation of the content comprises:
displaying a graph within a graph area in the graphical user interface, wherein the graph includes a primary node that identifies a base entity and a quantity of a subset of vectors in the plurality of vectors that include the base entity.

11. The method of claim 10, wherein displaying the graph comprises:
displaying a set of secondary nodes connected to the primary node in the graph in the graphical user interface, wherein a secondary node in the set of secondary nodes identifies a relevant entity that is related to the base entity identified by the primary node and a quantity for a portion of the subset of vectors that include the relevant entity.

12. The method of claim 7, wherein displaying, by the computer system, the visual representation of the content comprises:
displaying a listing of selectable items within a selection area in the graphical user interface,
wherein a selection of a selectable item in the listing of selectable items modifies a graph displayed in a graph area of the graphical user interface.

13. The method of claim 7, wherein transforming, by the computer system, the visual representation of the content comprises:
identifying a subset of vectors from the plurality of vectors that includes an entity selected based on the user input; and
identifying a plurality of relevant entities corresponding to the entity based on the subset of vectors.

14. The method of claim 13, wherein transforming, by the computer system, the visual representation of the content further comprises:
updating a listing of selectable items in a selection area in the graphical user interface based on the plurality of relevant entities identified.

15. The method of claim 13, wherein transforming, by the computer system, the visual representation of the content further comprises:
updating a graph in a graph area in the graphical user interface based on the entity selected by the user input and a portion of the plurality of relevant entities identified.

16. The method of claim 7, wherein displaying, by the computer system, the visual representation of the content comprises:
grouping a plurality of nodes of a self-organizing map to form a plurality of concept groupings, wherein the self-organizing map is generated based on the plurality of vectors;
displaying a plurality of graphical indicators on a map in the graphical user interface in which each graphical indicator in the plurality of graphical indicators represents at least one media source in the plurality of media sources; and
defining, visually, a plurality of concept regions on the map that represent the plurality of concept groupings, wherein each concept region in the plurality of concept regions includes a selected portion of the plurality of graphical indicators.

17. The method of claim 16, wherein transforming, by the computer system, the visual representation of the content further comprises:
zooming into the map from a current zoom level to a new zoom level based on a zoom input received through the graphical user interface; and
updating the plurality of graphical indicators displayed on the map based on the new zoom level.

18. The method of claim 16, wherein transforming, by the computer system, the visual representation of the content further comprises:
exploding out a cluster indicator based on the user input to visually represent a cluster of media sources represented by the cluster indicator.

19. The method of claim 7 further comprising:
displaying, by the computer system, a graphical presentation of a snapshot of the content in a portion of the plurality of media sources in the graphical user interface; and
updating, by the computer system, the graphical user interface as new content from the plurality of media sources is obtained.

20. The method of claim 7 further comprising:
building, by the computer system, the lexicon for the selected subject using at least one of user-specified factors, historical data, or a predetermined ontology.
